(19) United States
(12) Patent Application Publication
(10) Pub. No.: US 2025/0293522 A1
(43) Pub. Date: Sep. 18, 2025

(54) INSTANTANEOUS SYNCHRONIZATION AND LOW VOLTAGE RIDE THROUGH SYSTEMS AND METHODS FOR MULTIPLE GRID-TIED POWER INVERTERS WITHOUT USING PHASE-LOCKED-LOOP

(71) Applicant: The Florida State University Research Foundation, Inc., Tallahassee, FL (US)

(72) Inventors: Hui Li, Tallahassee, FL (US); Xiaofeng Dong, Tallahassee, FL (US); Xuli Quan, Tallahassee, FL (US)

(21) Appl. No.: 19/077,651

(22) Filed: Mar. 12, 2025

Related U.S. Application Data
(60) Provisional application No. 63/564,225, filed on Mar. 12, 2024.

(51) Int. Cl. H02J 3/16; H02J 3/38; H02J 3/46

(52) U.S. Cl. CPC H02J 3/16; H02J 3/381; H02J 3/46

(57) ABSTRACT

Systems, devices, and methods for controlling grid-tied inverters with instantaneous synchronization and low-voltage-ride-through (LVRT) capabilities under a wide range of grid cable impedance without using a phase-locked loop.

### RELATED APPLICATION

This U.S. application claims priority to, and the benefit of, U.S. Provisional Patent Application No. 63/564,225, filed Mar. 12, 2024, entitled “INSTANTANEOUS SYNCHRONIZATION AND LOW VOLTAGE RIDE THROUGH SYSTEMS AND METHODS FOR GRID-TIED POWER INVERTERS WITHOUT USING PHASE-LOCKED-LOOP,” which is incorporated by reference herein in its entirety.

### BACKGROUND

Conventional low-voltage-ride-through (LVRT) systems and methods for grid-tied inverter all have drawbacks, including: (1) specially designed LVRT control unit and/or additional hardware circuits are needed to perform the LVRT; and (2) inrush currents and oscillations are inevitable during the LVRT process due to the limitation of the controller characteristics and control bandwidth. Therefore, previous LVRT approaches increase the system cost and control complexity in order to achieve good LVRT performance.

Therefore, it would be desirable to provide LVRT devices, systems and methods that overcome challenges in the art, some of which are described herein.

### SUMMARY

Implementations of the present disclosure include a control system, device and method that measures the inverter output currents and the point-of-common-coupling (PCC) voltage that are sent to a deadbeat current control, along with current reference generated from real and reactive power references to achieve instantaneous synchronization for grid-tied inverters, thus eliminating the need for a phase-locked-loop to acquire frequency and phase angle information from the ac grid voltage. When LVRT happens, the corresponding power references are automatically reformed to update the current reference feeding the deadbeat current controller. In addition, the optimal future output voltage references of the inverter are generated by the developed discrete-time model under switching frequency to achieve fast dynamic control performance. In order to allow multiple parallel inverters operation under a wide range of grid cable impedance, PCC voltage feedforward is adopted to generate final voltage reference. This approach enables autonomous realization of a unified normal-state and LVRT control, substantially reducing current overshoots and oscillations during the LVRT process, thereby enhancing the reliability of grid-tied inverters. The disclosed control methods and system accomplish LVRT without requiring phase-locked loop, additional hardware circuits or sophisticated transient controllers, leading to a notable reduction in system cost and control complexity. The disclosed control systems and methods can apply to multiple grid-tied inverters under wide range of grid impedance.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

In an aspect, a control system for a network of grid inverters having at least one grid inverter, including a first inverter, is disclosed comprising a first controller operatively coupled to the first grid inverter, the first controller comprises a first low-voltage-ride-through (LVRT) detection unit configured to measure, in a first control cycle, a first point-of-common-coupling (PCC) voltage; receive, in the first control cycle, a first real power reference and a first reactive power reference; and in response to the measured first PCC voltage meeting an LVRT condition, generate a reformed first active power reference and a reformed first reactive power reference; a first current reference generation unit operatively coupled to the first LVRT detection unit, the current reference generation unit being configured to in response to the measured PCC voltage meeting the LVRT condition, generate a first three-phase instantaneous current reference using the measured first PCC voltage, the reformed first active power reference, and the reformed first reactive power reference; and in response to the measured PCC voltage not meeting the LVRT condition, generate the first three-phase instantaneous current reference using the measured first PCC voltage, the first real power reference, and the first reactive power reference; a first deadbeat-based current control unit operatively coupled to the first current reference generation unit, the deadbeat-based current control being configured to receive, in the first control cycle, a first inverter current from the first grid inverter; and generate, in the first control cycle, a first voltage reference using the first three-phase instantaneous current reference, the first inverter current, and the measured first PCC voltage, wherein the first voltage reference is used to make the first inverter current reach the first three-phase instantaneous current reference in a second control cycle; a first modulation unit (e.g., PWM generator) operatively coupled to the first current reference generation unit, the first modulation unit being configured to generate, in the first control cycle, a first switching signal by modulating (e.g., amplifying, reducing) the generated first voltage reference; and output the first switching signal to the network of grid inverters for controls in subsequent control cycles.

In some embodiments, each grid inverter is coupled with an inductive low-pass filter (i.e., L filter) configured to reduce alternating current (AC) components of an inverter current of the grid inverter.

In some embodiments, the control system described herein further comprises a second controller operatively coupled to a second grid inverter, the second controller comprises a second low-voltage-ride-through (LVRT) detection unit configured to measure, in the first control cycle, a second point-of-common-coupling (PCC) voltage; receive, in the first control cycle, a second real power reference and a second reactive power reference; and in response to the measured second PCC voltage meeting an LVRT condition, generate a reformed second active power reference and a reformed second reactive power reference; a second current reference generation unit operatively coupled to the first LVRT detection unit, the current reference generation unit being configured to in response to the measured PCC voltage meeting the LVRT condition, generate a second three-phase instantaneous current reference using the measured first PCC voltage, the reformed second active power reference, and the reformed second reactive power reference; and in response to the measured PCC voltage not meeting the LVRT condition, generate the second three-phase instantaneous current reference using the measured first PCC voltage, the second real power reference, and the second reactive power reference; a second deadbeat-based current control unit operatively coupled to the second current reference generation unit, the deadbeat-based current control being configured to receive, in the first control cycle, a second inverter current from the second grid inverter; and generate, in the first control cycle, a second voltage reference using the second three-phase instantaneous current reference, the second inverter current, and the measured second PCC voltage, wherein the second voltage reference is used to make the second inverter current reach the second three-phase instantaneous current reference in the second control cycle; a second modulation unit (e.g., PWM generator) operatively coupled to the second current reference generation unit, the second modulation unit being configured to generate, in the first control cycle, a second switching signal by modulating (e.g., amplifying, reducing) the generated second voltage reference; and output the second switching signal to the network of grid inverters for controls in subsequent control cycles.

In some embodiments, the first grid inverter and the second grid inverter are connected in parallel.

In some embodiments, the network of grid inverters is coupled to an AC grid via a cable, wherein the cable has a cable impedance.

In another aspect, a method for controlling a network of grid inverters having at least one grid inverter, including a first grid inverter, is disclosed comprising measuring, in a first control cycle, a first point-of-common-coupling (PCC) voltage; receiving, in the first control cycle, a first real power reference and a first reactive power reference; in response to the measured first PCC voltage meeting an LVRT condition, generating a reformed first active power reference and a reformed first reactive power reference; in response to the measured PCC voltage meeting the LVRT condition, generating a first three-phase instantaneous current reference using the measured first PCC voltage, the reformed first active power reference, and the reformed first reactive power reference; in response to the measured PCC voltage not meeting the LVRT condition, generating the first three-phase instantaneous current reference using the measured first PCC voltage, the first real power reference, and the first reactive power reference; receiving, in the first control cycle, a first inverter current from the first grid inverter; generating, in the first control cycle, a first voltage reference using the first three-phase instantaneous current reference, the first inverter current, and the measured first PCC voltage, wherein the first voltage reference is used to make the first inverter current reach the first three-phase instantaneous current reference in a second control cycle; generating, in the first control cycle, a first switching signal by modulating (e.g., amplifying, reducing) the generated first voltage reference; and outputting the first switching signal to the grid inverters for controls.

In some embodiments, the network of grid inverters further comprises a second grid inverter, and the method described herein further comprises measuring, in the first control cycle, a second point-of-common-coupling (PCC) voltage; receiving, in the first control cycle, a second real power reference and a second reactive power reference; in response to the measured second PCC voltage meeting an LVRT condition, generating a reformed second active power reference and a reformed second reactive power reference; in response to the measured PCC voltage meeting the LVRT condition, generating a second three-phase instantaneous current reference using the measured first PCC voltage, the reformed second active power reference, and the reformed second reactive power reference; in response to the measured PCC voltage not meeting the LVRT condition, generating the second three-phase instantaneous current reference using the measured first PCC voltage, the second real power reference, and the second reactive power reference; receiving, in the first control cycle, a second inverter current from the second grid inverter; generating, in the first control cycle, a second voltage reference using the second three-phase instantaneous current reference, the second inverter current, and the measured second PCC voltage, wherein the second voltage reference is used to make the second inverter current reach the second three-phase instantaneous current reference in the second control cycle; generating, in the first control cycle, a second switching signal by modulating (e.g., amplifying, reducing) the generated second voltage reference; and outputting the second switching signal to the grid inverters for controls.

In some embodiments, each grid inverter is coupled with an inductive low-pass filter (i.e., L filter) configured to reduce alternating current (AC) components of an inverter current of the grid inverter.

In some embodiments, the first grid inverter and the second grid inverter are connected in parallel.

In some embodiments, the network of grid inverters is coupled to an AC grid via a cable, wherein the cable has a cable impedance.

In another aspect, a non-transitory computer-readable medium for controlling a network of grid inverters having at least one grid inverter, including a first grid inverter, is disclosed having instructions stored thereon, wherein execution of the instructions by a processor causes the processor to measure, in a first control cycle, a first point-of-common-coupling (PCC) voltage; receive, in the first control cycle, a first real power reference and a first reactive power reference; in response to the measured first PCC voltage meeting an LVRT condition, generate a reformed first active power reference and a reformed first reactive power reference; in response to the measured PCC voltage meeting the LVRT condition, generate a first three-phase instantaneous current reference using the measured first PCC voltage, the reformed first active power reference, and the reformed first reactive power reference; in response to the measured PCC voltage not meeting the LVRT condition, generate the first three-phase instantaneous current reference using the measured first PCC voltage, the first real power reference, and the first reactive power reference; receive, in the first control cycle, a first inverter current from the first grid inverter; generate, in the first control cycle, a first voltage reference using the first three-phase instantaneous current reference, the first inverter current, and the measured first PCC voltage, wherein the first voltage reference is used to make the first inverter current reach the first three-phase instantaneous current reference in a second control cycle; generate, in the first control cycle, a first switching signal by modulating (e.g., amplifying, reducing) the generated first voltage reference; and output the first switching signal to the grid inverters for controls.

In some embodiments, the network of grid inverters further comprises a second grid inverter, wherein execution of the instructions by a processor further causes the processor to measure, in the first control cycle, a second point-of-common-coupling (PCC) voltage; receive, in the first control cycle, a second real power reference and a second reactive power reference; in response to the measured second PCC voltage meeting an LVRT condition, generate a reformed second active power reference and a reformed second reactive power reference; in response to the measured PCC voltage meeting the LVRT condition, generate a second three-phase instantaneous current reference using the measured first PCC voltage, the reformed second active power reference, and the reformed second reactive power reference; in response to the measured PCC voltage not meeting the LVRT condition, generate the second three-phase instantaneous current reference using the measured first PCC voltage, the second real power reference, and the second reactive power reference; receive, in the first control cycle, a second inverter current from the second grid inverter; generate, in the first control cycle, a second voltage reference using the second three-phase instantaneous current reference, the second inverter current, and the measured second PCC voltage, wherein the second voltage reference is used to make the second inverter current reach the second three-phase instantaneous current reference in the second control cycle; generate, in the first control cycle, a second switching signal by modulating (e.g., amplifying, reducing) the generated second voltage reference; and output the second switching signal to the grid inverters for controls.

In some embodiments, each grid inverter is coupled with an inductive low-pass filter (i.e., L filter) configured to reduce alternating current (AC) components of an inverter current of the grid inverter.

In some embodiments, the first grid inverter and the second grid inverter are connected in parallel.

In some embodiments, the network of grid inverters is coupled to an AC grid via a cable, wherein the cable has a cable impedance.

### BRIEF DESCRIPTION OF THE DRAWINGS

The components in the drawings are not necessarily to scale relative to each other. Like reference numerals designate corresponding parts throughout the several views.

FIG. 1A is a schematic block diagram of an exemplary control system for instantaneous synchronization and LVRT for grid-tied inverters.

FIG. 1B is a flowchart of an exemplary method for instantaneous synchronization and LVRT for grid-tied inverters.

FIG. 1C is a schematic block diagram of an exemplary system for multi-paralleled inverters with inductive (L) filter and cable impedance.

FIG. 1D illustrates an LVRT reference generation of the multi-paralleled inverters.

FIG. 1E illustrates an equivalent circuit for a deadbeat-control-based multi-paralleled inverter.

FIG. 1F illustrates a schematic block diagram of an exemplary system for multi-paralleled inverters using a deadbeat-based universal control, wherein each inverter has an inductive (L) filter and a cable impedance.

FIG. 1G illustrates a control flowchart to achieve unified LVRT and normal state control in the deadbeat-control-based multi-paralleled inverters.

FIG. 1H illustrates the graphical depiction of LVRT/ZVRT operation principle within switching cycles.

FIG. 1I illustrates the detailed discretized control diagram for the exemplary system where the function of the ith inverter current with respect to PCC voltage in discrete form can be derived from Equations 6 and 7 and shown in Equation 9.

FIG. 1J illustrates a voltage-current (V-I) curve of the inverter system with deadbeat control during LVRT transients based on Equation 9.

FIG. 1K illustrates a traditional control diagram for a traditional grid-tied inverter.

FIG. 1L illustrates the corresponding V-I curve for the traditional grid-tied inverter during LVRT transients.

FIG. 2 illustrates an exemplary LVRT curve of the grid-tied inverter.

FIG. 3 illustrates operating principles of the disclosed controller during LVRT.

FIG. 4 illustrates simulation results demonstrating the instantaneous synchronization of the proposed method.

FIG. 5 illustrates simulation results demonstrating zero-voltage-ride-through (ZVRT) of embodiments of the disclosed method.

FIG. 6A illustrates the equivalent circuit for a two-multi-paralleled-inverter system (i.e., two-inverter system).

FIG. 6B illustrates the Nyquist diagram of the deadbeat current controller with and without the low-pass filter (LPF) for the two-inverter system.

FIGS. 6C-6D illustrate the simulation results of two inverters with and without the PCC voltage LPF, respectively, under the following condition: the grid voltage drops to 0.50 p.u. at 0.1 s, lasted for 0.2 s, and then recovered.

FIG. 6E illustrates a two-inverter experimental testbed.

FIG. 6F illustrates steady-state experimental results of the two-inverter system with the deadbeat control algorithm connected to the AC grid.

FIG. 6G illustrates the experimental setup to verify the LVRT capability and stability of a single inverter connected to the grid emulator.

FIGS. 6H-6I illustrates the experimental results, for the setup in FIG. 6G, of two LVRT scenarios: (1) grid voltage (Vg) dropped to 0.5 p.u. and recovered after 0.2 seconds, and (2) v_{g} dropped to 0.3 p.u. and recovered after 0.2 seconds.

FIG. 7A illustrates a diagram of a grid-tied two-inverter system during LVRT transients with a conductor-inductor-conductor (CLC) grid impedance.

FIG. 7B shows the PCC voltage, inverter current, and voltage-current (V-I) trajectories of the two inverters in the two-inverter system during LVRT transients.

FIGS. 7C-7D each shows simulation results for the two-inverter system under LVRT.

FIGS. 7E-7F illustrate the V-I trajectories of the two-inverter system before, during, and after LVRT for FIG. 7C and FIG. 7D, respectively.

FIG. 7G shows a two-inverter grid-tied experimental testbed established in the laboratory.

FIG. 7H shows the experimental waveforms when grid voltage (v_{g}) dropped to 0.5 p.u and recovered after 0.2 seconds.

FIG. 7I illustrates the experimental waveforms for two scenarios when v_{g} dropped to 0.3 p.u. and recovered after 0.2 seconds.

FIG. 8 illustrates an example computing device that may be used to practice aspects described herein.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Unless defined otherwise, all technical and scientific terms used herein have the same meaning as commonly understood by one of ordinary skill in the art.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

5“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

Systems, devices, and methods are described herein that facilitate using a power device (e.g., a power electronic circuit (inverter)) for inversion and regulation of electrical power. Generally, an inverter changes dc power from a power supply/generator such as a solar photovoltaic array, wind turbine, fuel cells, batteries, microturbines and the like to a single-or poly-phase ac power (e.g., three-phase) for connection to an electrical grid. The methods, systems and devices described herein may be used on Si, SiC, GaN, etc. inverters.

As generally referred to herein, “power devices” are semiconductor devices used as switches or rectifiers in power electronics. Power devices include, but are not limited to, silicon (Si) MOSFETs, silicon insulated-gate bipolar transistors (Si IGBTs), gallium nitride high-electron-mobility transistors (GaN HEMTs), silicon carbide (SiC) MOSFETs, and the like.

The disclosure describes control methods, devices and systems for grid-tied inverters with instantaneous synchronization and low-voltage-ride-through (LVRT) capabilities under wide-range of grid cable impedance without using phase-locked loop.

As noted herein, grid-tied inverters are comprised of switching devices responsible for connecting the direct current (dc) power supply to the alternating current (ac) grid and managing the energy transmission. The control system needs to achieve good power and current control performance while ensuring a fast dynamic response, particularly in scenarios involving substantial grid cable impedance. The LVRT function ensures the stability and reliability of grid-tied inverters. It is desired that the inverters remain connected to the ac power grid, consistently supplying currents to facilitate grid recovery throughout the LVRT process.

The disclosed control devices, systems and methods measure the inverter output currents and the point-of-common-coupling (PCC) voltage that will be sent to a deadbeat current control, along with current reference generated from real and reactive power references to achieve instantaneous synchronization for grid-tied inverters, thus eliminating the need for a phase-locked- loop (PLL) to acquire frequency and phase angle information from the ac grid voltage. When LVRT happens, the corresponding power reference will be modified to update the current reference feeding the deadbeat current controller. In addition, the optimal future output voltage references of the inverter are generated by the developed discrete-time model under switching frequency to achieve fast dynamic control performance. In order to allow multiple parallel inverters operation under a wide range of grid cable impedance, PCC voltage feedforward is adopted to generate final voltage reference. This approach enables autonomous realization of a unified normal-state and LVRT control, substantially reducing current overshoots and oscillations during the LVRT process, thereby enhancing the reliability of grid-tied inverters. The disclosed control devices, systems and methods accomplish LVRT without requiring additional hardware circuits or sophisticated transient controllers, leading to a notable reduction in system cost and control complexity, applicable to multiple grid-tied inverters under wide range of grid impedance.

Features of the disclosure include: (1) no phase-locked-loop is required; (2) achieving instantaneous synchronization; (3) no extra hardware circuit are required for LVRT; (4) a unified control for both normal state and LVRT; (5) fast dynamics and high control bandwidth; (6) ability to operate under wide-range grid cable impedance; and (7) applied for multiple grid-tied units. Therefore, the disclosed embodiments result in a significant reduction in cost and design complexity, concurrently enhancing the robustness of grid-tied inverters.

### Example Systems

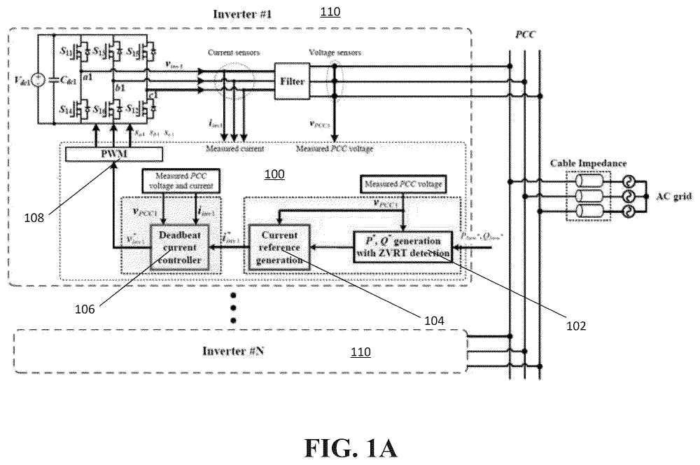

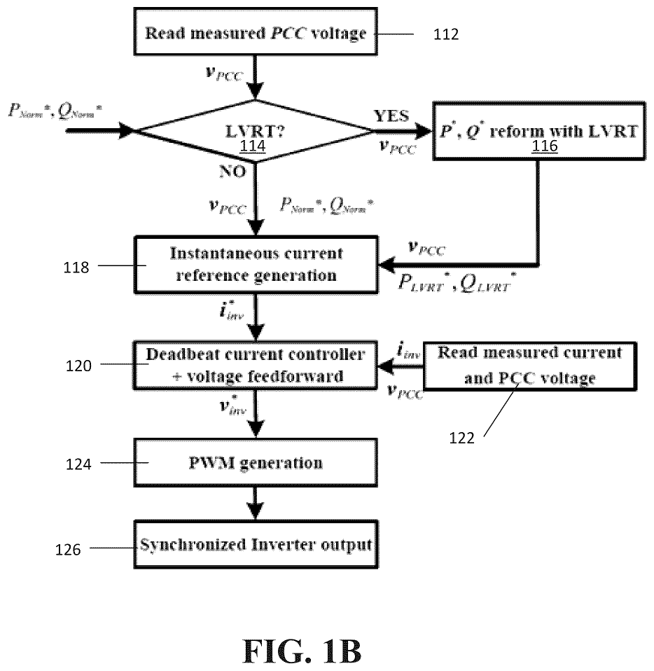

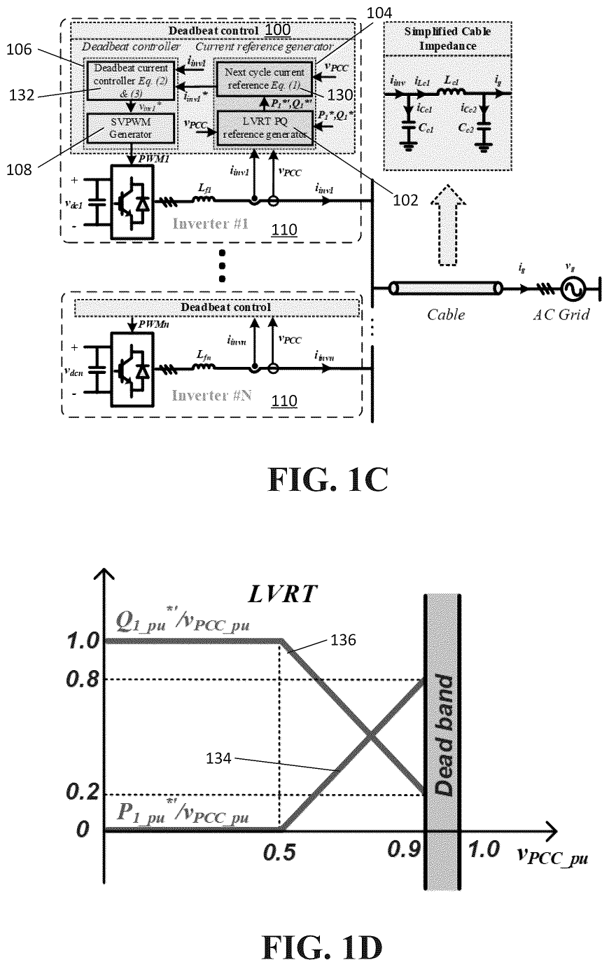

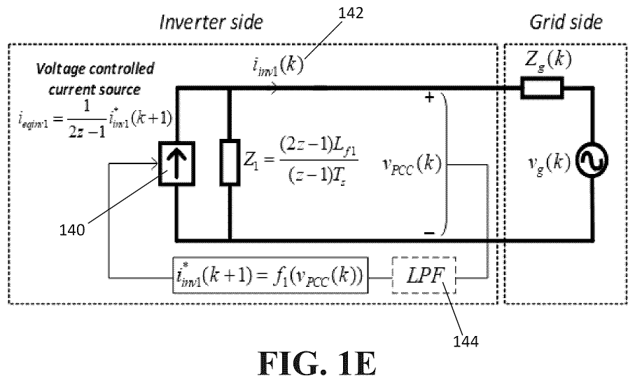

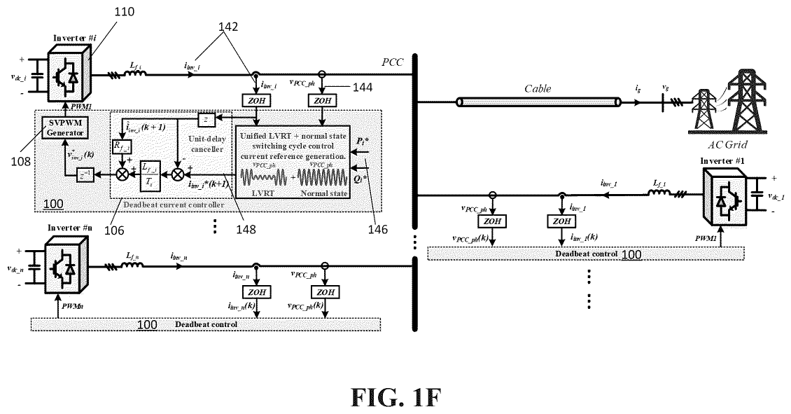

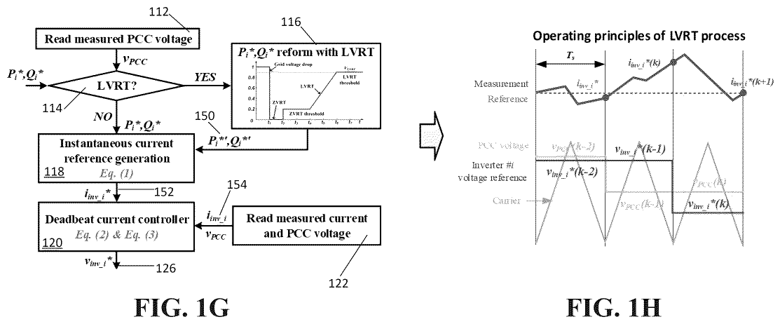

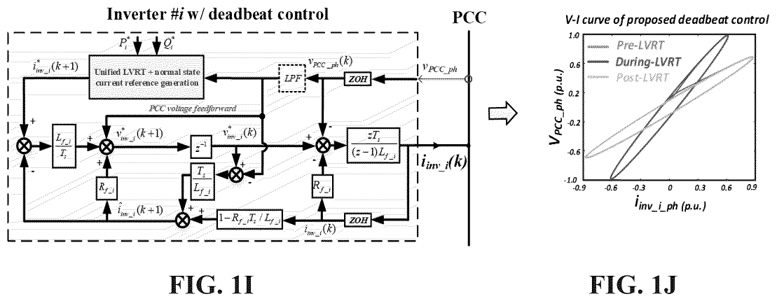

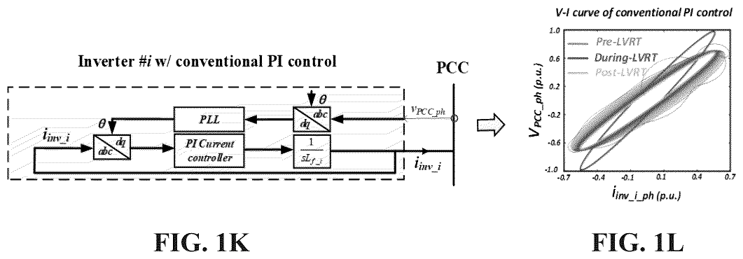

Example System #1. Referring now to FIG. 1A, a schematic block diagram of an exemplary control system for grid-tied inverters with instantaneous synchronization and LVRT capabilities is presented. One embodiment of a controller 100 comprises a power reference generation with LVRT detection unit 102, an instantaneous current reference generation unit 104, a deadbeat-based current control unit 106, and a modulation unit 108. The inverter output currents and the point-of-common-coupling (PCC) voltages are measured and used in the controller 100. The PCC voltage feedforward control is applied to enhance the control performance. The controller 100 can be used for multiple grid-tied inverters 110 and can handle the wide range of grid cable impedance.

FIG. 1B is a flowchart of an exemplary method for instantaneous synchronization and LVRT for grid-tied inverters. At 112, measured PCC voltage (v_{PCC}) is read. At 114, the v_{PCC} is used to detect the LVRT scenario. If, at 114, LVRT is detected, then the method goes to 116 where the active power reference (P*) and reactive power reference (Q*) is reformed according the LVRT requirements. Then, the measured PCC voltage as well as the reformed generated active power reference (P_{LVRT}*) and reactive power reference (Q_{LVRT}*) are sent to the instantaneous current reference generation unit where at 118 the three-phase instantaneous current references (iᵢₙᵥ*) are generated using the measured PCC voltage as well as the reformed generated active power reference (P_{LVRT}*) and reactive power reference (Q_{LVRT}*). Returning to 114, if LVRT is not detected, then the normal active power reference (P_{Norm}*) and reactive power reference (Q_{Norm}*) and the measured PCC voltage are sent to the instantaneous current reference generation unit where at 118 the three-phase instantaneous current references (iᵢₙᵥ*) are generated using the measured PCC voltage as well as the normal generated active power reference (P*) and reactive power reference (Q*). The generated three-phase instantaneous current references (iᵢₙᵥ*) are then sent from the current reference generation unit to the deadbeat current control unit, where, at 120, the deadbeat current control unit generates, using the measured current (iᵢₙᵥ) and PCC voltage (v_{PCC}) from 122, the optimal voltage references (vᵢₙᵥ*) for the next cycle to make the current reaches to its reference value. Finally, at 124 the switching signals of the grid-tied inverter are generated and produce the synchronized inverter output at 126.

Example System #2. FIG. 1C shows a schematic block diagram of an exemplary system for multi-paralleled inverters with inductive (L) filter and cable impedance. As shown, the inverters 110 (e.g., #1, . . . #N) are connected in parallel, wherein each inverter employs a deadbeat control module 100 comprising a deadbeat current controller 106 and current reference generator 104.

Referring to FIG. 1C, the multi-paralleled inverters (e.g., SiC) are connected without a phase-locked loop (PLL). Each inverter 110 (e.g., #1, . . . #N) can comprise a current reference generator 104 and deadbeat controller 106. The current reference generator 104 can generate the next cycle current reference 130, while the deadbeat controller 106 can generate output pulse-wave-modulated (PWM) signals via PWM generator 108.

For the current reference generator, the next cycle three-phase current reference i_{inv_1}* (k+1) can be derived per Equation Set 1.

$$\{ \begin{matrix}{P}_{1}^{*} = {v}_{PCC \_α} {i}_{inv 1 \_α} - {v}_{PCC \_β} {i}_{inv \_ 1 \_β} \\ {Q}_{1}^{*} = {v}_{PCC \_α} {i}_{inv 1 \_β} - {v}_{PCC \_β} {i}_{inv \_ 1 \_α}\end{matrix}$$

$$\text{=>} \{ \begin{matrix}{i}_{inv \_ 1 \_α}^{*} ( k + 1 ) = \frac{2}{3} \frac{{v}_{PCC \_α} ( k ) . {P}_{1}^{*} ( k ) - {v}_{PCC \_β} ( k ) . {Q}_{1}^{*} ( k )}{{{v}_{PCC \_α} ( k )}^{2} + {{v}_{PCC \_β} ( k )}^{2}} \\ {i}_{inv 1 \_β}^{*} ( k + 1 ) = \frac{2}{3} \frac{{v}_{PCC \_β} ( k ) . {P}_{1}^{*} ( k ) - {v}_{PCC \_α} ( k ) . {Q}_{1}^{*} ( k )}{{{v}_{PCC \_α} ( k )}^{2} + {{v}_{PCC \_β} ( k )}^{2}}\end{matrix}$$

$$C = [ \begin{matrix}1 & - \frac{1}{2} & - \frac{1}{2} \\ 0 & \frac{\sqrt{3}}{2} & - \frac{\sqrt{3}}{2}\end{matrix} ] , {i}_{inv \_ 1}^{*} ( k + 1 ) = [ \begin{matrix}{i}_{inv \_ 1 \_α}^{*} ( k + 1 ) \\ {i}_{inv \_ 1 \_ b}^{*} ( k + 1 ) \\ {i}_{inv \_ 1 \_ c}^{*} ( k + 1 )\end{matrix} ] ,$$

$${i}_{inv \_ 1}^{*} ( k + 1 ) = {C}^{T} {i}_{inv \_ 1 \_αβ}^{*} ( k + 1 )$$

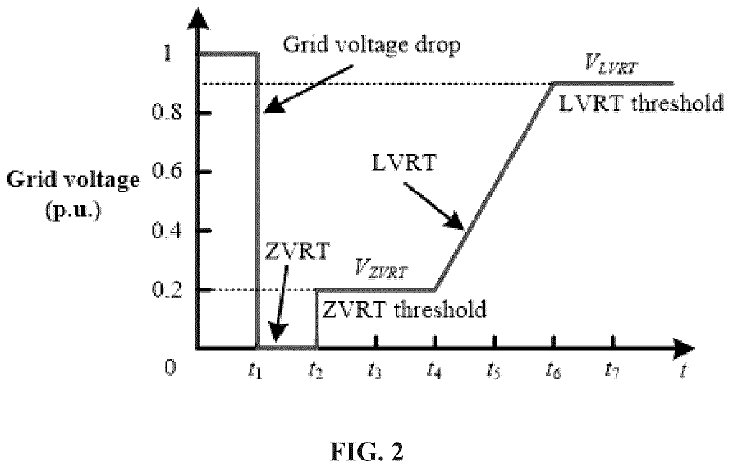

FIG. 1D illustrates an LVRT reference generation (by the reference generator 102 in FIG. 1C) of the multi-paralleled inverters. For the multi-paralleled inverters to achieve LVRT capability, the output power reference values can be generated based on FIG. 2B. If the PCC voltage drops below 0.9 p.u., the inverter should output active and reactive power according to the curves 134 and 136, respectively.

After the current reference is generated, three-phase voltage reference vᵢₙᵥ₁* can be obtained through a deadbeat current controller 132 (in FIG. 1C). From FIG. 1, the discrete-time model of the filter L_{f_1} can be derived by applying Forward Euler discretization. And the predicted next cycle three-phase current î_{inv_1}(k+1) can be obtained from Equation 2.

$${L}_{f \_ 1} \frac{{i}_{inv \_ 1} ( k + 1 ) - {i}_{inv \_ 1} ( k )}{{T}_{s}} = {v}_{inv \_ 1}^{*} ( k ) - {R}_{f \_ 1} {i}_{inv \_ 1} ( k ) - {v}_{P C C} ( k ) \text{=>} {\hat{ι}}_{inv \_ 1} ( k + 1 ) = \frac{{T}_{s}}{{L}_{f \_ 1}} [ {v}_{inv \_ 1}^{*} ( k ) - {v}_{P C C} ( k ) ] + ( 1 - \frac{{R}_{f \_ 1} {T}_{s}}{{L}_{f \_ 1}} ) {i}_{inv \_ 1} ( k ) \qquad ( Eq . 2 )$$

In Equation 2, R_{f_1} is the filter resistance, v_{PCC}(k) is the kth cycle three-phase PCC voltage, i_{inv_1}(k) is the kth cycle three-phase current, and Tₛ is the sampling period. The sampling period can be the same as the switching period.

Since the sampling frequency fₛ can be higher than the voltage frequency, PCC voltage may not vary within one switching cycle, i.e., v_{PCC}(k+1)=v_{PCC}(k). Besides, if the inverter can operate normally, the output current can reach its reference in the next cycle, i.e., l_{inv_1}*(k+1)=i_{inv_1}(k+2). Therefore, in the next cycle, an output voltage, defined per Equation 3, can be generated.

$${v}_{inv \_ 1}^{*} ( k + 1 ) = \frac{{L}_{f \_ 1}}{{T}_{s}} [ {i}_{inv \_ 1} ( k + 2 ) - {i}_{inv \_ 1} ( k + 1 ) ] + {R}_{f \_ 1} {i}_{inv \_ 1} ( k + 1 ) + {v}_{P C C} ( k + 1 ) \text{=>} {v}_{inv \_ 1}^{*} ( k + 1 ) = \frac{{L}_{f \_ 1}}{{T}_{s}} [ {i}_{inv \_ 1}^{*} ( k + 1 ) - {\hat{ι}}_{inv \_ 1} ( k + 1 ) ] + {R}_{f \_ 1} {\hat{ι}}_{inv \_ 1} ( k + 1 ) + {v}_{P C C} ( k ) \qquad ( Eq . 3 )$$

Finally, the PWM generator can generate PWM signals based on the voltage reference defined per Equation 3.

To further analyze the deadbeat-based multi-paralleled inverters, an equivalent circuit model is derived. Taking inverter #1 (see FIG. 1C) as an example, Equation 4 can be obtained from Equations 2 and 3.

$${i}_{inv \_ 1} ( k ) = \frac{1}{2 z - 1} {i}_{inv \_ 1}^{*} ( k + 1 ) - \frac{( z - 1 ) {T}_{s}}{( 2 z - 1 ) {L}_{f \_ 1}} {v}_{P C C} ( k ) = {i}_{eqinv \_ 1}^{*} ( k ) \qquad ( Eq . 4 )$$

Equation 1 describes the relationship between the current reference and the PCC voltage, which can be represented as f₁(v_{PCC}(k)) in Equation 5.

$${i}_{inv \_ 1}^{*} = {f}_{1} ( {v}_{P C C} ) \qquad ( Eq . 5 )$$

FIG. 1E shows an equivalent circuit for a deadbeat-control-based multi-paralleled inverter that can be developed based on Equations 4 and 5. When PCC overvoltage happens, the voltage-controlled current source 140, denoted as i_{eqinv_1}, and the output current 142, denoted as i_{inv_1}, may decrease instantly, suppressing the overvoltage within one switching cycle. Therefore, the deadbeat control can perform faster than a proportional-integral (PI) control, which can require the action of cascaded control loops such as PLL and current loop, resulting in a slower response to overvoltage suppression.

A PCC voltage low-pass filter 144 (LPF) can also be added to the circuit in FIG. 1E to improve the stability of single and multi-paralleled inverters with the deadbeat control.

Example System #3. FIG. 1F shows a schematic block diagram of an exemplary system for multi-paralleled inverters using a deadbeat-based universal control, wherein each inverter has an inductive (L) filter and a cable impedance. Taking inverter #i (shown as 110) in FIG. 1F, the exemplary control method measures the inverter output current i_{inv_i} (shown as 142) and the PCC voltage v_{PCC} (shown as 144), along with active and reactive power references (Pᵢ*, Qᵢ*) (shown as 146) to generate switching-cycle-based current reference i_{inv_i}* (shown as 148) feeding to a deadbeat current controller 106, to achieve instantaneous synchronization and control for grid-tied inverters, without a PLL to acquire frequency and phase angle information from the AC grid voltage v_{g}. When LVRT occurs, the corresponding power reference can be modified (Pᵢ*′, Qᵢ*′) (shown as 146) to update the current reference 148 feeding the deadbeat current controller 106. In addition, the future output voltage references v_{inv_i}* of the inverter are generated by the developed model discretized at switching frequency to achieve fast dynamic control performance.

The exemplary system can provide autonomous realization of a seamless normal-state and LVRT control, reducing current overshoots and oscillations during the LVRT process and thereby enhancing the reliability of grid-tied inverters. The exemplary control method can accomplish LVRT without additional hardware circuits or transient controllers, reducing system cost and control complexity. The exemplary control method can apply to multiple grid-tied inverters in the presence of grid impedance, as illustrated in FIG. 1F.

FIG. 1G shows a control flowchart to achieve unified LVRT and normal state control in the deadbeat-control-based multi-paralleled inverters. In the control flowchart in FIG. 1G, the PCC voltage (measured at 112) is used to detect the LVRT scenario 114 and provide the active power reference and reactive power reference (Pᵢ*, Qᵢ*) to 116 according to the LVRT requirements. Then, the measured PCC voltage (measured at 112), as well as the generated active and reactive power references 150, are sent to the instantaneous current reference generation unit 118 to generate the instantaneous current reference i_{inv_i}* vectors (shown as 152) in α,β-frame, and abc-frame based on Equation 6.

$${P}_{i}^{*} ( k ) + j {Q}_{i}^{*} ( k ) = {\vec{v}}_{PCC \_αβ} ( k ) . {\vec{ι}}_{inv \_ i \_αβ} \\ \text{=>} \{ \begin{matrix}{i}_{inv \_ i \_α}^{*} ( k + 1 ) = \frac{2}{3} \frac{{v}_{PCC \_α} ( k ) . {P}_{i}^{*} ( k ) - {v}_{PCC \_β} ( k ) . {Q}_{i}^{*} ( k )}{{{v}_{PCC \_α} ( k )}^{2} + {{v}_{PCC \_β} ( k )}^{2}} \\ {i}_{inv \_ i \_β}^{*} ( k + 1 ) = \frac{2}{3} \frac{{v}_{PCC \_β} ( k ) . {P}_{i}^{*} ( k ) - {v}_{PCC \_α} ( k ) . {Q}_{i}^{*} ( k )}{{{v}_{PCC \_α} ( k )}^{2} + {{v}_{PCC \_β} ( k )}^{2}}\end{matrix} \\ \text{=>} [ \begin{matrix}{i}_{inv \_ i \_ α}^{*} ( k + 1 ) \\ {i}_{inv \_ i \_ b}^{*} ( k + 1 ) \\ {i}_{inv \_ i \_ c}^{*} ( k + 1 )\end{matrix} ] = [ \begin{matrix}1 & 0 \\ - 1 / 2 & \sqrt{3} / 2 \\ - 1 / 2 & - \sqrt{3} / 2\end{matrix} ] [ \begin{matrix}{i}_{inv \_ i \_α}^{*} ( k + 1 ) \\ {i}_{inv \_ i \_ b}^{*} ( k + 1 )\end{matrix} ] \qquad ( Eq . 6 )$$

Meanwhile, the unit-delay canceller may predict the next cycle current vector using Forward Euler discretization defined per Equation 7.

$$\begin{matrix}{L}_{f\_i} \frac{{i}_{i n {v}_{-} i} ( k + 1 ) - {i}_{i n {v}_{-} i} ( k )}{{T}_{s}} = {v}_{i n {v}_{-} i}^{*} ( k ) - {R}_{{f}_{-} i} {i}_{i n {v}_{-} i} ( k ) - {v}_{P C {C}_{-} p h} ( k ) \\ \text{=>} {\hat{l}}_{i n {v}_{-} i} ( k + 1 ) = \frac{{T}_{s}}{{L}_{{f}_{-} i}} [ {v}_{i n {v}_{-} i}^{*} ( k ) - {v}_{P C {C}_{-} p h} ( k ) ] + ( 1 - \frac{{R}_{{f}_{-} i} {T}_{s}}{{L}_{{f}_{-} i}} ) {i}_{i n {v}_{-} i} ( k )\end{matrix} \qquad ( Eq . 7 )$$

In Equation 7, L_{f_i} is the filter inductance, R_{f_i} is parasitic resistance, and Tₛ is the sampling period.

Since the PCC voltage (at 112) does not change in one sampling cycle, and the inverter output voltage reference for deadbeat control 120 is generated to control the inverter current track the current reference 154 in the next cycle (at 122), the next cycle voltage reference 126 can be obtained in Equation 8.

$${v}_{i n {v}_{-} i}^{*} ( k + 1 ) = \frac{{L}_{{f}_{-} i}}{{T}_{s}} {i}_{i n {v}_{-} i}^{*} ( k + 1 ) + ( {R}_{{f}_{-} i} - \frac{{L}_{{f}_{-} i}}{{T}_{s}} ) {\hat{l}}_{\dot{l} n {v}_{-} i} ( k + 1 ) + {v}_{P C {C}_{-} p h} ( k ) \qquad ( Eq . 8 )$$

FIG. 1H shows the graphical depiction of LVRT/ZVRT operation principle within switching cycles. The inverter current and the PCC voltage are measured and sent to the controller in each cycle. In FIG. 1H, at the kth sampling cycle, the PCC voltage drops to a low-voltage condition, and the controller detects it. The power references Pᵢ* and Qᵢ* can be reformed according to the LVRT standards. The next cycle current reference can be calculated according to the measured PCC voltage, Pᵢ* and Qᵢ*. Subsequently, the deadbeat controller can generate the three-phase voltage reference to control the current reaching its reference in the next cycle. The switching-cycle-based control can provide a dynamic response and suppress the inrush current during the LVRT transient.

The dynamic response feature is further verified by the inverter output V-I characteristics and comparison with that of conventional control. FIG. 1I illustrates the detailed discretized control diagram for the exemplary system where the function of the ith inverter current with respect to PCC voltage in discrete form can be derived from Equations 6 and 7 and shown in Equation 9.

$${i}_{i n {v}_{-} i} ( k ) = \frac{( 1 - z ) {T}_{s} {v}_{P C {C}_{-} p h} ( k )}{{z}^{2} {L}_{{f}_{-} i}} - \frac{{i}_{i n {v}_{-} i}^{*} ( k )}{( - z )} \qquad ( Eq . 9 )$$

FIG. 1J shows a V-I curve of the inverter with deadbeat control during LVRT transients based on Equation 9. Before the grid voltage dip, the pre-LVRT curve represents the steady-state operation before LVRT. When the voltage drops to 0.7 p.u., the inverter current increases, and the during-LVRT trajectory depicts the dynamic transition. After the transient process, the operating point would move to the post-LVRT curve, representing the post-LVRT state.

FIG. 1K shows a traditional control diagram for a traditional grid-tied inverter. FIG. 1L shows the corresponding V-I curve for the traditional grid-tied inverter during LVRT transients.

As shown in FIGS. 1K-1L, the transient trajectory of traditional control involves many loops (i.e., oscillations) before settling into the post-LVRT steady state, indicating a longer transient process. In contrast, the exemplary control method (i.e., deadbeat-based control) facilitates the inverter to transition directly to the post-LVRT steady state, demonstrating a dynamic response due to its capability to achieve instantaneous current control and synchronization during the LVRT period. The cascaded multiple PI control loops in traditional methods can result in a slow dynamic response during LVRT.

### Experimental Results and Additional Examples

A study was conducted to develop, simulate, and evaluate the exemplary system for (i) dead-beat-based grid-tied inverters and (ii) deadbeat-based multi-paralleled inverters.

### Deadbeat-Based Grid-Tied Inverters

FIG. 2 shows an LVRT voltage curve example of the grid-tied inverter. The grid-tied inverter needs to keep a connection with the AC grid for a period of time when LVRT happens and continue providing the current according to the LVRT standards and specifications to help the AC grid recovery. In FIG. 2, the grid voltage drops from 1 p.u. (per-unit) of the rated voltage to 0 p.u. of the rated voltage at t₁. At t₂, the grid voltage recovered to V_{ZVRT}. And from t₄ to t₆, the grid voltage slowly increased to a higher level V_{ZVRT}. V_{LVRT} is the threshold of the LVRT. The inverter is operating normally when grid voltage is larger than this value. And the inverter is required to implement LVRT control when grid voltage is smaller than this value. V_{ZVRT} is the threshold of the zero-voltage-ride-through (ZVRT).

Values of V_{LVRT}, V_{ZVRT}, t₁-t₂, t₂-t₄, and t₄-t₆ are determined by the real situation and specified requirements in different applications. In general, the value of the V_{LVRT} is 0.9 p.u. of the rated grid voltage, the value of the V_{ZVRT} is 0.2 p.u. of the rated grid voltage, t₁-t₂ is set to 0.15 s, t₂-t₄ is set to 1 s, and t₄-t₆ is set to 2 s.

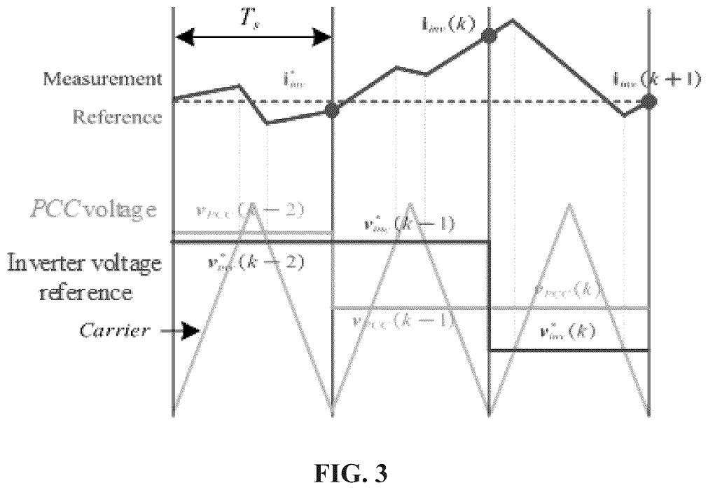

The graphic operating principles of the exemplary controller during the LVRT process are presented in FIG. 3. The inverter current iᵢₙᵥ(k) and the PCC voltage is measured and sent to the controller in each cycle. At kth sampling cycle, the PCC voltage drops to a low-voltage condition, and it is detected by the controller. The power references P* and Q* are then reformed according to the LVRT standards, and the next cycle current reference i*(k+1) can be calculated according to the measured PCC voltage and P* and Q*. After that, the deadbeat controller generates the optimal voltage reference to make the currents reach the references in the next cycle, and the switching signals can be generated with the appropriate PWM modulation unit. The control bandwidth is the same with the sampling frequency, which allows the fast dynamic control performance of the proposed predictive controller and suppress the inrush current during the LVRT transient.

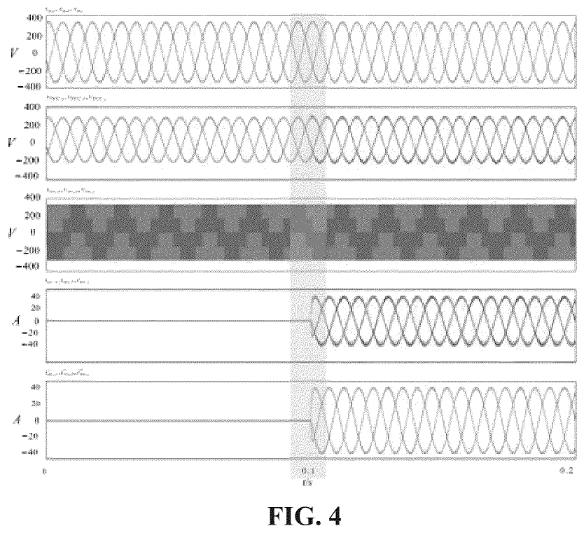

FIG. 4 presents the synchronization simulation results of the disclosed method. At t=0.1 s, the inverter connects to the ac grid with rated power reference. The grid voltages, PCC voltages, inverter output voltage, inverter output currents, and the current references are shown at 1^{st}, 2^{nd}, 3^{rd}, 4^{th}, and 5^{th} waveforms screens in FIG. 4, respectively. With the disclosed control method, the grid-tied inverter can realize the instantaneous synchronization within several switching cycles, as FIG. 4 shows. The inverter output power and currents are well controlled and there is no current overshoot or oscillation during the synchronization transient. There is no phase-lock-loop needed during the synchronization process.

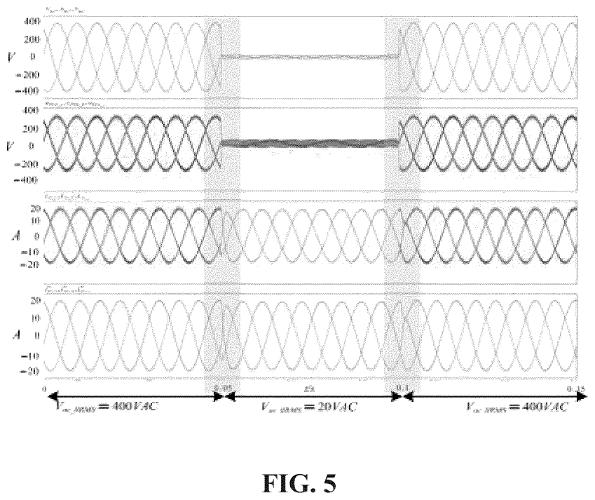

The simulation results of the disclosed ZVRT method are depicted in FIG. 5. At t=0.05 s, the grid voltage experiences a drop to 0.05 p.u. Following a grid voltage-sag duration of 0.05 s, the grid voltage recovers to normal conditions at t=0.1 s. The inverter is controlled to supply the rated reactive current during the ZVRT process. The grid voltages, PCC voltages, inverter output currents, and the current references are shown at 1^{st}, 2^{nd}, 3^{rd}, and 4^{th} waveforms screens in FIG. 5, respectively. With the proposed control method, the inverter can achieve fast, stable, and reliable control during the ZVRT, and the transient time and overshoot currents are significantly mitigated as FIG. 5 shows. The inverter output currents are well controlled and there is no current overshoot during the ZVRT transients. Additionally, the incorporation of PCC voltage feedforward control ensures optimal inverter operation across a wide range of grid cable impedance. The disclosed method is a unified control method for both steady states and transients, which requires no modes identification or modes switching during ZVRT process.

Compared to conventional grid-tied control technologies with low-voltage-ride-through (LVRT) capability, the disclosed instantaneous synchronization and LVRT control method for grid-tied inverters does not require phase-locked loop and additional low-voltage detection circuits, which reduces the system cost and complexity. The instantaneous synchronization can be achieved within several switching cycles, which greatly improves the inverter grid connection and start-up dynamics. The inrush current-free feature of the synchronization process is achieved, ensuring the prevention of fault protection triggers and enhancing the inverter robustness. In addition, no complex and time-consuming controller parameter design process is required. The seamless integration of LVRT using the same control law for normal state control sets the disclosed approach apart, markedly reducing control and design complexity when compared to other methods. Due to the high control bandwidth and fast response features of the disclosed method, the inrush currents and oscillations can be greatly mitigated. Thereby, the reliability of the grid-tied inverters can be significantly enhanced. Moreover, the disclosed method adopts the PCC voltage feedforward technology, enabling decoupled control for multiple parallel inverters and facilitating operation across a wide range of grid cable impedance. This versatility further underscores the robustness and adaptability of the disclosed control methodology.

### Deadbeat-Based Multi-Paralleled Inverters

The stability analysis for the multi-paralleled inverter system with a deadbeat control was divided into two steps. First, the large-signal stability of a single inverter was analyzed using a Lyapunov-based method. Then, the Nyquist diagram was applied to analyze the small-signal stability of a two-inverter system. The LVRT simulation results of the two-inverter system were presented to verify the theoretical analysis.

Lyapunov-Based Stability Analysis. To analyze the stability of one inverter under LVRT, the Lyapunov-based method was applied to study the large-signal stability for the deadbeat control. According to Lyapunov theory, for any moment t, if there is a positive scalar δ limiting the difference between the actual current i_{inv_1}(t) and equilibrium state current i_{eq_1}, then the system was stable, and i_{eq_1} can be defined as equilibrium point per Equation 10.

$$\vert \vert {i}_{i n {v}_{-} 1} ( t ) - {i}_{eq \_ 1} \vert \vert \leq δ , ∀ t \geq {t}_{0} \qquad ( Eq . 10 )$$

To prove the stability of the deadbeat control in the multi-paralleled inverter system, the first step was to find the limit d. From Equations 2 and 3, the controller model can be written per Equation 11.

$${v}_{inv \_ 1} ( k ) = {L}_{f \_ 1} \frac{{i}_{i n {v}_{-} 1}^{*} ( k ) - {i}_{i n {v}_{-} 1} ( k )}{{T}_{s}} + {R}_{f \_ 1} {i}_{{inv}_{-} 1} ( k ) + {v}_{P C C} ( k ) \qquad ( Eq . 11 )$$

Meanwhile, the current difference can be rewritten in a discrete-time domain per Equation 12.

$$\begin{matrix}\vert \vert {i}_{inv \_ 1} ( k ) - {i}_{eq \_ 1} \vert \vert = \vert \vert {i}_{inv \_ 1} ( k ) - {i}_{inv \_ 1} ( k - 1 ) + {i}_{inv \_ 1} ( k - 1 ) - {i}_{eq \_ 1} \vert \vert \\ \leq \vert \vert Δ {i}_{inv \_ 1} + max \vert {i}_{inv \_ 1}^{*} \vert - min \vert {i}_{eq \_ 1} \vert \vert \vert \leq \vert \vert 2 Δ {i}_{inv \_ 1 \_ max} + 2 {I}_{inv \_ 1 \_ max}^{*} \vert \vert\end{matrix} \qquad ( Eq . 12 )$$

In Equation 12, Δi_{inv_1_max} is the maximum current difference for two adjacent sampling instants, and I*inv_1_max is the maximum current reference value.

Then, based on the control diagram and simplified capacitance-inductance-capacitance (CLC) cable impedance model, as shown in FIG. 1C, the discretized differential equations of filter inductor L_{f_1}, cable capacitor C_{c1}, and cable inductor L_{c1} can be obtained as Equation 13.

$$\{ \begin{matrix}{L}_{f 1} \frac{{i}_{inv \_ 1} ( k + 1 ) - {i}_{inv \_ 1} ( k )}{{T}_{s}} = {v}_{inv \_ 1} ( k ) - {R}_{f \_ 1} {i}_{inv \_ 1} ( k ) - {v}_{P C C} ( k ) \\ {L}_{c 1} \frac{{i}_{L c 1} ( k + 1 ) - {i}_{L c 1} ( k )}{{T}_{s}} = {v}_{P C C} ( k ) - {v}_{g} ( k ) \\ {C}_{c 1} \frac{{v}_{P C C} ( k + 1 ) - {v}_{P C C} ( k )}{{T}_{s}} = {i}_{inv \_ 1} ( k ) - {i}_{L c 1} ( k )\end{matrix} \qquad ( Eq . 13 )$$

Therefore, the maximum current difference for two adjacent sampling instants Δi_{inv_1_max} can be derived per Equation 14.

$$Δ {i}_{inv \_ 1 \_ max} = \frac{{T}_{s}}{{L}_{f \_ 1}} {‖ {v}_{inv \_ 1} ( k ) - {R}_{f \_ 1} {i}_{inv \_ 1} ( k ) - {v}_{PCC} ( k ) - \frac{{T}_{s} {i}_{inv \_ 1} ( k )}{2 {C}_{c 1}} + \frac{{T}_{s}^{2}}{4 {L}_{c 1} {C}_{c 1}} [ {v}_{P C C} ( k ) - {v}_{g} ( k ) ] ‖}_{max} \qquad ( Eq . 14 )$$

$$\leq \frac{{T}_{s}}{{L}_{f \_ 1}} ‖ \frac{2 {V}_{d c}}{3} + {R}_{f \_ 1} {I}_{inv \_ 1 \_ max}^{*} + ( \frac{{T}_{s}^{2}}{4 {L}_{c 1} {C}_{c 1}} - 1 ) {v}_{P C C} ( k ) + \frac{{T}_{s} {i}_{inv \_ 1} ( k )}{2 {C}_{c 1}} + \frac{{T}_{s}^{2} {V}_{g}}{4 {L}_{c 1} {C}_{c 1}} ‖$$

$$\leq \frac{{T}_{s}}{{L}_{f \_ 1}} ‖ \frac{2 {V}_{d c}}{3} + {R}_{f \_ 1} {I}_{inv \_ 1 \_ max}^{*} + \vert \frac{{T}_{s}^{2}}{4 {L}_{c 1} {C}_{c 1}} - 1 \vert . \frac{2 {V}_{dc \_ 1}}{3} + \frac{{T}_{s} {I}_{inv \_ 1 \_ max}^{*}}{2 {C}_{c 1}} + \frac{{T}_{s}^{2} {V}_{g}}{4 {L}_{c 1} {C}_{c 1}} ( {V}_{g} + \frac{2 {V}_{dc \_ 1}}{3} ) ‖$$

In Equation 10, V_{dc_1} is the DC side voltage, and V_{g} is the amplitude of grid voltage. If a variable A is defined per Equation 11, then the limit δ of the current difference can be obtained per Equation 16 by combining Equations 10, 12, 14, and 15.

$$A = ‖ \frac{2 {V}_{d c}}{3} + {R}_{f\_ 1} {I}_{inv \_ 1 \_ max}^{*} + \vert \frac{{T}_{s}^{2}}{4 {L}_{c 1} {C}_{c 1}} - 1 \vert \cdot \frac{2 {V}_{dc \_ 1}}{3} + \frac{{T}_{s} {I}_{inv \_ 1 \_ max}^{*}}{2 {C}_{c 1}} + \frac{{T}_{s}^{2} {V}_{g}}{4 {L}_{c 1} {C}_{c 1}} ( {V}_{g} + \frac{2 {V}_{dc \_ 1}}{3} ) ‖ \qquad ( Eq . 15 )$$

$$\{ \begin{matrix}‖ {i}_{inv \_ 1} ( t ) - {i}_{eq \_ 1} ‖ \leq δ \\ δ = \frac{2 {T}_{s}}{{L}_{f \_ 1}} A + 2 {I}_{inv \_ 1 \_ max}^{*}\end{matrix} \qquad ( Eq . 16 )$$

Though the limitation was derived, it was an essential but insufficient prerequisite for the system's stability for the equilibrium point. Only the maximum tracking errors of the output current can be obtainable if Equation 16 is satisfied.

To guarantee the convergence of the current, the uniform asymptotic stability criterion should be met [11]. According to the uniform asymptotic stability criterion, if the system was stable, there should be a λ that satisfies Equation 17.

$$\begin{matrix}σ ( k ) - σ ( k - 1 ) \leq λ , λ < 0 \text{=>} {lim}_{k \to ∞} ‖ {i}_{inv \_ 1} ( k ) - {i}_{inv \_ 1}^{*} ( k ) ‖ = 0 \\ σ ( k ) = ‖ {i}_{inv \_ 1} ( k ) - {i}_{inv \_ 1}^{*} ( k ) ‖ = {‖ {i}_{err \_ 1} ( k ) ‖}^{2}\end{matrix} \qquad ( Eq . 17 )$$

If Equation 17 can be proved accurate, the stability of the inverter can be assured. PCC voltage may not change within one switching cycle, i.e., v_{PCC}(k+1)=v_{PCC}(k). Then, combined with Equation 1, v_{PCC} can be derived per Equation 18.

$${v}_{P C C} ( k - 1 ) = {v}_{P C C} ( k - 2 ) \text{=>} {i}_{inv \_ 1}^{*} ( k ) = {i}_{inv \_ 1}^{*} ( k - 1 ) \qquad ( Eq . 18 )$$

Based on Equation 13, the Equation Set 19 can be obtained.

$${i}_{inv \_ 1} ( k ) = \frac{{T}_{s}}{{L}_{f 1} + {L}_{c 1}} [ \frac{{L}_{f \_ 1}}{{T}_{s}} ( {i}_{inv \_ 1}^{*} ( k ) - {i}_{inv \_ 1} ( k - 1 ) ) + {v}_{P C C} ( k - 1 ) - {v}_{g} ( k ) ] + {i}_{inv \_ 1} ( k - 1 ) , \qquad ( Eq . 19 )$$

$${v}_{P C C} ( k ) = \frac{{T}_{s}}{{C}_{c 1}} [ {i}_{l n {v}_{-} 1} ( k - 1 ) - {i}_{L c 1} ( k - 1 ) ] + {v}_{P C C} ( k - 1 ) ,$$

$${i}_{L c 1} ( k ) = \frac{{T}_{s}}{{L}_{c 1}} [ {v}_{P C C} ( k - 1 ) - {v}_{g} ( k ) ] + {i}_{L c 1} ( k - 1 )$$

Then, from Equation 19, kth cycle current i_{inv_1}(k) and i_{Lc1}(k) can be rewritten per Equation Set 20.

$${i}_{inv \_ 1} ( k ) = \frac{{T}_{s}}{{L}_{f \_ 1} + {L}_{c 1}} [ \frac{{L}_{f \_ 1}}{{T}_{s}} ( {i}_{inv \_ 1}^{*} ( k ) - {i}_{inv \_ 1} ( k - 1 ) ) + {v}_{P C C} ( k - 2 ) - {v}_{g} ( k - 1 ) + \frac{{T}_{s}}{{C}_{c 1}} ( {i}_{inv \_ 1} ( k - 2 ) - {i}_{L c 1} ( k - 2 ) ) ] + {i}_{inv \_ 1} ( k - 1 ) , \qquad ( Eq . Set 20 )$$

$${i}_{L c 1} ( k ) = \frac{{T}_{s}^{2}}{{T}_{s}^{2} + 4 {π}^{2} {L}_{c 1} {C}_{c 1}} {i}_{inv \_ 1} ( k ) + \frac{4 {π}^{2} {L}_{c 1} {C}_{c 1}}{{T}_{s}^{2} + 4 {π}^{2} {L}_{c 1} {C}_{c 1}} {i}_{inv \_ 1} ( k - 1 )$$

Combining Equation Sets 19 and 20, Equation Set 21 can be obtained.

$${i}_{inv \_ 1} ( k ) = \frac{{T}_{s}}{{L}_{f \_ 1} + {L}_{c 1}} {i}_{inv \_ 1}^{*} ( k ) - \frac{{T}_{s}}{{L}_{f \_ 1} + {L}_{c 1}} {i}_{inv \_ 1} ( k - 1 ) + \frac{{T}_{s}^{2} {L}_{c 1}}{( {L}_{f \_ 1} + {L}_{c 1} ) ( {T}_{s}^{2} + 4 {π}^{2} {L}_{c 1} {C}_{c 1} )} [ {i}_{inv \_ 1} ( k - 1 ) - {i}_{inv \_ 1} ( k - 2 ) ] + \frac{4 {π}^{2} {L}_{c 1}^{2} {L}_{c 1}}{( {L}_{f \_ 1} + {L}_{c 1} ) ( {T}_{s}^{2} + 4 {π}^{2} {L}_{c 1} {C}_{c 1} )} [ {i}_{inv \_ 1} ( k - 2 ) - {i}_{inv \_ 1} ( k - 3 ) ] + {i}_{inv \_ 1} ( k - 1 ) , \qquad ( Eq . Set 21 )$$

$${i}_{inv \_ 1}^{*} ( k ) - {i}_{inv \_ 1} ( k ) = \frac{{L}_{c 1}}{{L}_{f \_ 1} + {L}_{c 1}} ( {i}_{inv \_ 1}^{*} ( k ) - {i}_{inv \_ 1} ( k - 1 ) - \frac{{T}_{s}^{2} {L}_{c 1}}{{T}_{s}^{2} + 4 {π}^{2} {L}_{c 1} {C}_{c 1}} [ {i}_{inv \_ 1} ( k - 1 ) - {i}_{inv \_ 1} ( k - 2 ) ] - \frac{4 {π}^{2} {L}_{c 1}^{2} {L}_{c 1}}{{T}_{s}^{2} + 4 {π}^{2} {L}_{c 1} {C}_{c 1}} [ {i}_{inv \_ 1} ( k - 2 ) - {i}_{inv \_ 1} ( k - 3 ) ] )$$

Then, the tracking errors can be expressed per Equation 22.

$${i}_{err \_ 1} ( k ) = {i}_{inv \_ 1}^{*} ( k ) - {i}_{inv \_ 1} ( k ) = \frac{{L}_{c 1}}{{L}_{f \_ 1} + {L}_{c 1}} ( {i}_{err \_ 1} ( k - 1 ) + \frac{{T}_{s}^{2} {L}_{c 1}}{{T}_{s}^{2} + 4 {π}^{2} {L}_{c 1} {C}_{c 1}} ( [ {i}_{err \_ 1} ( k - 1 ) - {i}_{err \_ 1} ( k - 2 ) ] + \frac{4 {π}^{2} {L}_{c 1}^{2} {L}_{c 1}}{{T}_{s}^{2} + 4 {π}^{2} {L}_{c 1} {C}_{c 1}} [ {i}_{err \_ 1} ( k - 2 ) - {i}_{err \_ 1} ( k - 3 ) ] ) \qquad ( Eq . 22 )$$

Based on Equation Set 21 and Equation 22, Equation 23 can be derived.

$${i}_{err \_ 1} ( k ) = \frac{{L}_{c 1}}{{L}_{f \_ 1} + {L}_{c 1}} ( {i}_{err \_ 1} ( k - 1 ) + \frac{{T}_{s}^{2} {L}_{c 1}}{{T}_{s}^{2} + 4 {π}^{2} {L}_{c 1} {C}_{c 1}} [ {i}_{err \_ 1} ( k - 1 ) - {i}_{err \_ 1} ( k - 2 ) ] + \frac{4 {π}^{2} {L}_{c 1}^{2} {L}_{c 1}}{{T}_{s}^{2} + 4 {π}^{2} {L}_{c 1} {C}_{c 1}} [ {i}_{inv \_ 1} ( k - 2 ) - {i}_{inv \_ 1} ( k - 3 ) ] ) \leq \frac{{L}_{c 1}}{{L}_{f \_ 1} + {L}_{c 1}} {i}_{err \_ 1} ( k - 1 ) \qquad ( Eq . 23 )$$

Equation 23 can lead to Equation 24.

$${i}_{err \_ 1} ( k ) \leq \frac{{L}_{c 1}}{{L}_{f \_ 1} + {L}_{c 1}} {i}_{err \_ 1} ( k - 1 ) < {i}_{err \_ 1} ( k - 1 ) \text{=>} {‖ {i}_{err \_ 1} ( k ) ‖}^{2} < {‖ {i}_{err \_ 1} ( k - 1 ) ‖}^{2} \text{=>} {σ}_{1} ( k ) - {σ}_{1} ( k - 1 ) \leq λ < 0 \qquad ( Eq . 24 )$$

Therefore, the uniform asymptotic stability criterion was satisfied, and the current tracking errors eventually decreased to zero with the deadbeat control.

As shown in the analysis, the PCC voltage did not change within two consecutive switching cycles. A PCC voltage LPF with a cut-off frequency can help maintain the stability of the exemplary system. A similar stabilizing effect of the LPF for multiple paralleled inverters was also present in the small signal stability analysis of the two-inverter system.

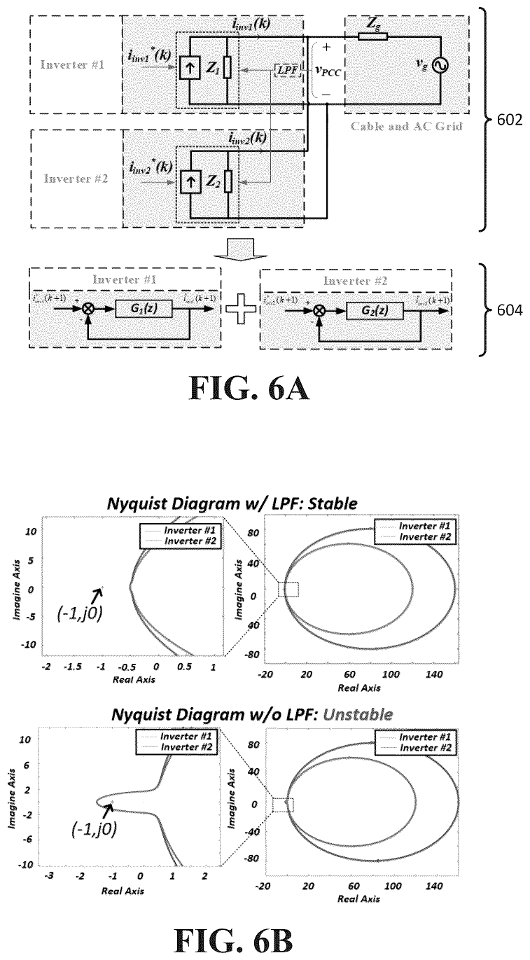

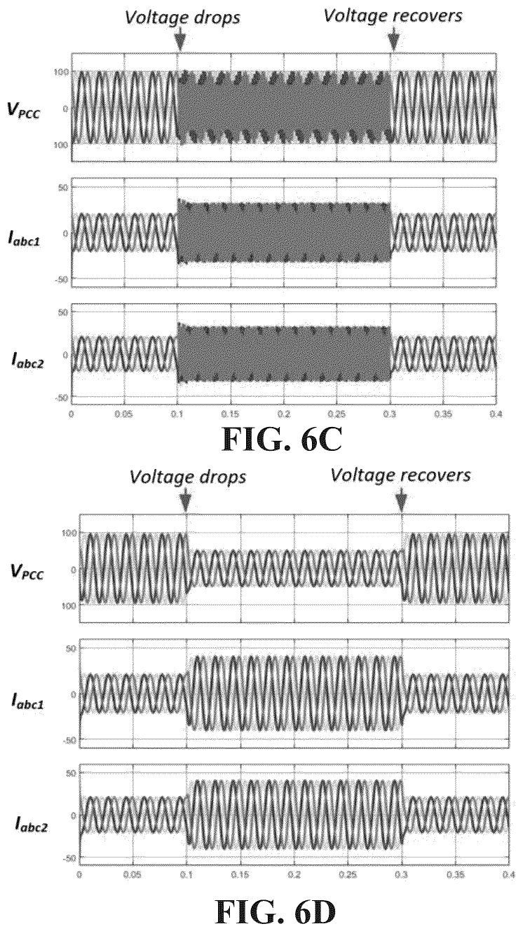

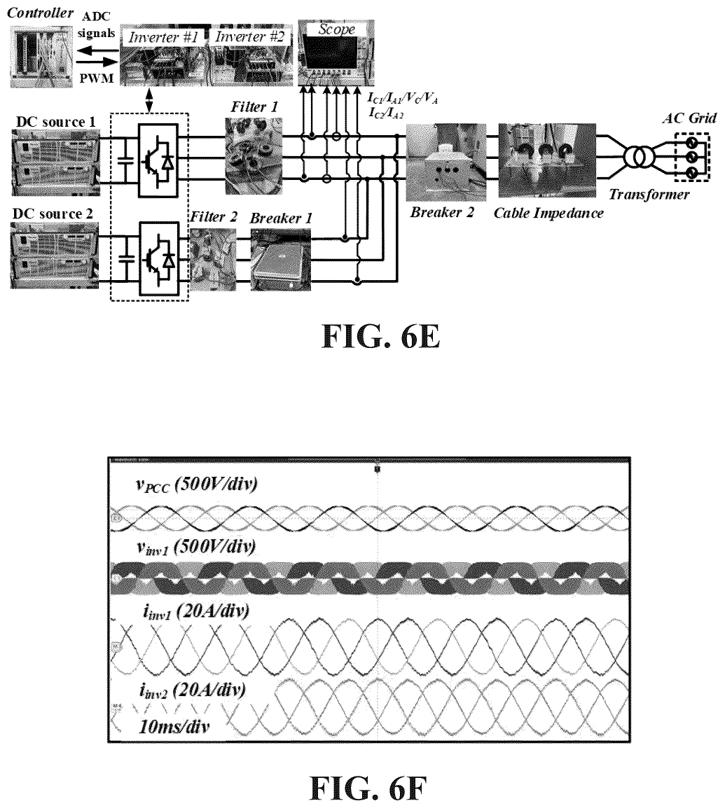

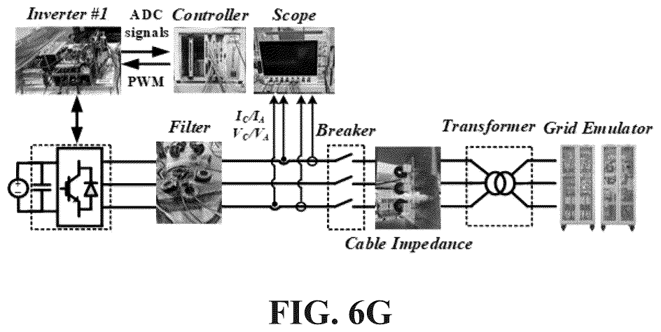

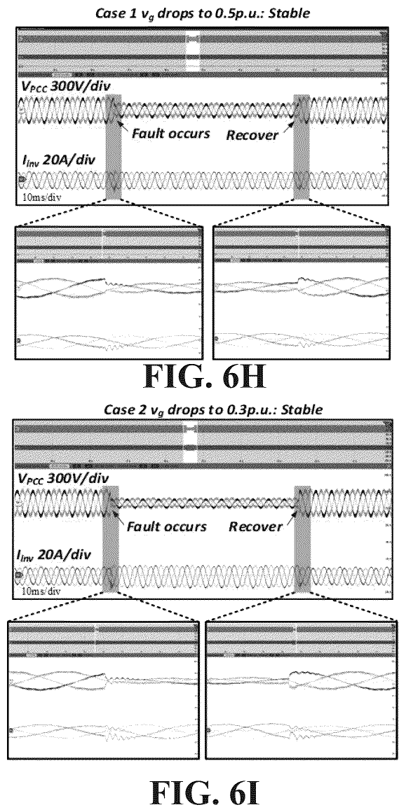

Nyquist Diagram-Based Small Signal Stability Analysis. Nyquist diagram was applied to analyze the small-signal stability of the current loop for the deadbeat control in the multi-paralleled inverter system. A two-inverter system was taken as an example in this analysis with the corresponding equivalent circuit model shown in FIG. 6A.

FIG. 6A shows the equivalent circuit 604 for a two-multi-paralleled-inverter system 602 (i.e., two-inverter system). In FIG. 6A, G₁(z) refers to the open-loop transfer function from i_{inv_1}*(k+1) to î_{inv_1}(k+1), while G₂(z) refers to the open-loop transfer function from i_{inv_2}(k+1) to i_{inv_2}(k+1). Thus, the current loop transfer function of each inverter can be written in Equation 25.

$$\frac{{\hat{ι}}_{inv \_ 1} ( k + 1 )}{{i}_{inv \_ 1}^{*} ( k + 1 )} = \frac{{G}_{1} ( z )}{1 + {G}_{1} ( z )} , \frac{{\hat{ι}}_{inv \_ 2} ( k + 1 )}{{i}_{inv \_ 2}^{*} ( k + 1 )} = \frac{{G}_{2} ( z )}{1 + {G}_{2} ( z )} \qquad ( Eq . 25 )$$

The Nyquist diagram of each inverter can then be plotted. FIG. 6B shows the Nyquist diagram of the deadbeat current controller with and without the LPF for the two-inverter system. To be consistent with the experimental testbed, the active power and reactive power references of both inverters were chosen as 3 kW and 0 Var, respectively. The other parameters were set as follows: v_{g_line_rms}=120V/60 Hz, L_{f_1}=600 μH, L_{f_2}=800 μH, R_{f_1}=R_{f_2}=0.25 Ω, fₛ=50 kHz, C_{c1}=C_{c2}=0.33 μF, L_{c1}=0.48 mH, and the cut-off frequency f_{c} of the LPF was selected as 1.2 kHz. FIG. 6B shows that the two-inverter system became stable with the LPF, demonstrating that the LPF enhanced the stability of multi-paralleled inverters.

A two-inverter system under LVRT conditions was simulated in Matlab/Simulink using the same parameters as shown above. FIGS. 6C-6D show the simulation results of two inverters with and without the PCC voltage LPF, respectively, under the following condition: the grid voltage drops to 0.50 p.u. at 0.1 s, lasted for 0.2 s, and then recovered.

The simulation results demonstrated that: (1) a PCC voltage LPF enhanced the stability, and (2) a two-inverter system remained stable under LVRT conditions with the deadbeat control and a well-designed LPF, consistent with the aforementioned stability analysis.

Experimental Verification. A two-inverter experimental testbed was established in the laboratory. FIG. 6E shows the two-inverter experimental testbed in the experiment. The PQ references, P denotes active power and Q denotes reactive power, of both inverters were chosen as 3 kW and 0 Var, respectively. The other parameters of the inverters were vg_line_rms=120V/60 Hz, L_{f_1}=600 μH, L_{f_2}=800 μH, and fₛ=50 kHz. The cable impedance parameters were: C_{c1}=C_{c2}=0.023 μF, and L_{c1}=0.024 mH. The LPF cut-off frequency of both inverters was selected as f_{c}=1.2 kHz. These parameters were the same as those used in the small signal stability analysis and simulation.

FIG. 6F shows the steady-state experimental results of the two-inverter system with the deadbeat control algorithm connected to the AC grid. In FIG. 6F, the two inverters operated stably with the deadbeat control, consistent with the stability analysis based on the Nyquist diagram.

FIG. 6G shows the experimental setup to verify the LVRT capability and stability of a single inverter connected to the grid emulator. The deadbeat control algorithm was implemented on a digital controller (e.g., Myway PE-Expert4) to control the inverter. The filter inductance of this inverter was selected to be 600 μH. Other key parameters, such as switching frequency and cable impedance, remained the same as those in the 2-inverter testbed.

FIGS. 6H-6I show the experimental results, for the setup in FIG. 6G, of two LVRT scenarios: (1) V_{g} dropped to 0.5 p.u. and recovered after 0.2 seconds, and (2) v_{g} dropped to 0.3 p.u. and recovered after 0.2 seconds. From the experimental results in FIG. 6H, the proposed control facilitated the inverter's stability during the LVRT transients, consistent with the Lyapunov-based stability analysis under large signal conditions. Additionally, the zoomed-in figures illustrated that current and voltage overshoot were minimal during LVRT, with fast transients completed within switching cycles, verifying the fast dynamics demonstrated by the equivalent circuit model.

### Universal-Deadbeat-Control-Based Multi-Paralleled Inverters

Lyapunov-Based Stability Analysis. The V-I characteristics analysis revealed that the grid-tied inverter with the proposed deadbeat control behaved as an active impedance, achieving an ultrafast response. Therefore, the Nyquist stability criteria based on the small signal model was inadequate for analyzing stability, particularly during LVRT transients. In the study, Lyapunov function was developed for multi-paralleled inverters with the deadbeat control, and the corresponding Lyapunov-based stability criterion was applied to verify that the control strategy ensured large-signal stability such as LVRT, even in the presence of grid impedance.

The Lyapunov-based method was aimed at large-signal stability analysis, defining a Lyapunov function V(x) that satisfies the conditions [10′] defined per Equation Set 26.

$$V ( x ) \geq 0 \qquad ( Eq . Set 26 )$$

$$\dot{V} ( x ) \leq 0$$

The current tracking error of exemplary control was selected as a state variable. Taking the inverter as an example, the state variable was denoted as xᵢ, which can be defined in Equation 27.

$${x}_{i} ( k ) = {i}_{inv \_ i}^{*} ( k ) - {i}_{inv \_ i} ( k + 1 ) \qquad ( Eq . 27 )$$

Equation 7 can be rewritten in terms of xᵢ as shown in Equation 28.

$${L}_{f \_ i} \frac{{dx}_{i}}{dt} = {L}_{f \_ i} \frac{{di}_{inv \_ i}^{*}}{dt} - {v}_{inv \_ i} + {v}_{PCC \_ ph} + {R}_{f \_ i} {i}_{inv \_ i} \qquad ( Eq . 28 )$$

By discretizing Equation 28 at k-th and (k+1)-th sampling cycle, respectively, Equation Set 29 can be obtained, leading to Δxᵢ(k)/Δxᵢ(k+1), as illustrated in Equation 30.

$$Δ {x}_{i} ( k ) = {x}_{i} ( k ) - {x}_{i} ( k - 1 ) \qquad ( Eq . Set 29 )$$

$$Δ {x}_{i} ( k + 1 ) = {x}_{i} ( k + 1 ) - {x}_{i} ( k )$$

$$( \frac{{L}_{f \_ i}}{{T}_{s}} [ {x}_{i} ( k + 1 ) {x}_{i} ( k ) - {x}_{i} ( k ) {x}_{i} ( k - 1 ) ] + [ - \frac{{L}_{f \_ i}}{{T}_{s}} {i}_{inv \_ i}^{*} ( k - 1 ) + \frac{{L}_{f \_ i}}{{T}_{s}} {i}_{inv \_ i} ( k + 1 ) - {v}_{inv \_ i} ( k ) + {v}_{PCC \_ ph} ( k ) + {R}_{f \_ i} {i}_{inv \_ i} ( k ) ] [ {x}_{i} ( k + 1 ) - {x}_{i} ( k ) ] ) - ( [ \frac{{L}_{f \_ i}}{{T}_{s}} {i}_{inv \_ i}^{*} ( k + 1 ) - \frac{{L}_{f \_ i}}{{T}_{s}} {i}_{inv \_ i} ( k + 1 ) - {v}_{inv \_ i} ( k + 1 ) + {v}_{PCC \_ ph} ( k + 1 ) ] [ {x}_{i} ( k ) - {x}_{i} ( k - 1 ) ] + {R}_{f \_ i} {i}_{inv \_ i} ( k + 1 ) {i}_{inv \_ i}^{*} ( k ) - {R}_{f \_ i} {i}_{inv \_ i} ( k + 1 ) {x}_{i} ( k - 1 ) ) = - {R}_{f \_ i} {{i}_{inv \_ i} ( k + 1 )}^{2} \qquad ( Eq . 30 )$$

If the left-hand side of Equation 30 was defined as \dot{V}ᵢ, then Equation 30 can be reformulated as Equation 31, satisfying Equation Set 26 as shown in Equation 31.

$${\dot{V}}_{i} = \frac{{V}_{i} ( k ) - {V}_{i} ( k - 1 )}{{T}_{s}} = - {R}_{f \_ i} {{i}_{inv \_ i} ( k + 1 )}^{2} \leq 0 \qquad ( Eq . 31 )$$

From Equations 30 and 31, the Lyapunov function Vᵢ(k) for an ith inverter with the exemplary control can be derived in Equation 32, where Vᵢ(0), the constant of integration, can take any constant value. To ensure Vᵢ(k)≥0, Vᵢ(0) should satisfy the Equation 33.

$${V}_{i} ( k ) = \frac{{L}_{f \_ i}}{2} [ {x}_{i} ( k + 1 ) {x}_{i} ( k ) - {x}_{i} ( 1 ) {x}_{i} ( 0 ) ] + \frac{{L}_{f \_ i}}{2} {\sum }_{j = 1}^{k} ( [ {x}_{i} ( j - 1 ) - {x}_{i} ( j + 1 ) + \frac{2 {R}_{f \_ i}}{{L}_{f \_ i}} {x}_{i} ( j ) ] {x}_{i} ( j ) - [ \frac{2 {R}_{f \_ i}}{{L}_{f \_ i}} {i}_{inv \_ i}^{*} ( j ) + \frac{4 {R}_{f \_ i}}{{L}_{f \_ i}} {x}_{i} ( j ) ] {i}_{inv \_ i}^{*} ( j ) ) + {V}_{i} ( 0 ) = {V}_{i} ( 0 ) - {T}_{s} {\sum }_{j = 1}^{k} {R}_{f \_ i} {{i}_{inv \_ i} ( j + 1 )}^{2} \qquad ( Eq . 32 )$$

$${V}_{i} ( 0 ) \geq {T}_{s} {\sum }_{j = 1}^{k} [ {R}_{f \_ i} {{i}_{inv \_ i} ( j + 1 )}^{2} ] \qquad ( Eq . 33 )$$

Since the right-hand side of Equation 33 is finite, a suitable Vᵢ(0) can be determined to satisfy Equation 33, guaranteeing that Vᵢ(k)≥0 is always achievable.

Vᵢ(k) can be separated into Kᵢ(k), representing kinetic energy, and Uᵢ(k) as potential energy. Thus, Vᵢ(k) can be reformulated in Equation Set 34, where Kᵢ(k) and Uᵢ(k) are expressed individually.

$${V}_{i} ( k ) = {K}_{i} ( k ) + {U}_{i} ( k ) , \qquad ( Eq . Set 34 )$$

$${K}_{i} ( k ) = \frac{{L}_{f \_ i}}{2} [ {x}_{i} ( k + 1 ) {x}_{i} ( k ) - {x}_{i} ( 1 ) {x}_{i} ( 0 ) ] ,$$

$${U}_{i} ( k ) = \frac{{L}_{f \_ i}}{2} {\sum }_{j = 1}^{k} ( [ {x}_{i} ( j - 1 ) - {x}_{i} ( j + 1 ) + \frac{2 {R}_{f \_ i}}{{L}_{f \_ i}} {x}_{i} ( j ) ] {x}_{i} ( j ) - [ \frac{2 {R}_{f \_ i}}{{L}_{f \_ i}} {i}_{inv \_ i}^{*} ( j ) + \frac{4 {R}_{f \_ i}}{{L}_{f \_ i}} {x}_{i} ( j ) ] {i}_{inv \_ i}^{*} ( j ) ) + {V}_{i} ( 0 )$$

The V(k) of the multi-paralleled inverter system with the deadbeat control should include the Lyapunov function of each unit, as shown in Equation 35, which also satisfies Equation Set 26.

$$V ( k ) = {\sum }_{i = 1}^{n} {V}_{i} ( k ) = {\sum }_{i = 1}^{n} [ {K}_{i} ( k ) + {U}_{i} ( k ) ] = K ( k ) + U ( k ) \text{=>} V ( k ) = {\sum }_{i = 1}^{n} {V}_{i} ( k ) \geq 0 , \dot{V} ( k ) = {\sum }_{i = 1}^{n} {\dot{V}}_{i} ( k ) \leq 0 \qquad ( Eq . 35 )$$

In fact, V(k) represents the total energy of the system, while K(k) and U(k) correspond to the system's kinetic energy and potential energy, respectively. During the transient process, if the total energy at the system's initial point exceeded the total energy at its unstable equilibrium point (UEP), the operating point may not converge to the stable equilibrium point (SEP), leading to transient instability. Furthermore, if the total energy at the SEP was close to that of the UEP, the system was more prone to small-signal instability.

The large-signal stability of multi-paralleled inverters with the exemplary control method can be analyzed using the developed Lyapunov function. Taking LVRT transients as an example, the voltage dropped at the k_{O}-th cycle serves as the initial point, the UEP occurred at the k_{U}-th cycle, and the SEP at the k_{S}-th cycle. Based on the Lyapunov-based stability criterion, two types of energy margins can be defined per Equation Set 36.

$$Δ {V}_{O 2 U} = V ( {k}_{U} ) - V ( {k}_{O} ) = [ K ( {k}_{U} ) - K ( {k}_{O} ) ] + [ U ( {k}_{U} ) - U ( {k}_{O} ) ] = Δ {U}_{O 2 U} \qquad ( Eq . Set 36 )$$

$$Δ {V}_{S 2 U} = V ( {k}_{U} ) - V ( {k}_{S} ) = [ K ( {k}_{U} ) - K ( {k}_{S} ) ] + [ U ( {k}_{U} ) - U ( {k}_{S} ) ] = Δ {U}_{S 2 U}$$

ΔV_{O2U} and ΔU_{OSU} represent the energy margin between the initial point and the UEP, while ΔV_{S2U} and ΔU_{S2U} represent the energy margin between the UEP and SEP. The system remained stable if both energy margins were positive (ΔU_{O2U}>0 and ΔU_{S2U}>0); Otherwise, the system became unstable. To ensure ΔU_{O2U} and ΔU_{S2U} were positive, Equation Set 37 should be satisfied, which can be derived from Equation Set 36 by solving the system Lyapunov function Equation 35 based on Equation 32.

$${\sum }_{i = 1}^{n} {i}_{inv \_ i}^{*} ( {k}_{O} + 1 ) {i}_{inv \_ i} ( {k}_{O} + 1 ) < {\sum }_{i = 1}^{n} \{ [ {i}_{inv \_ 1}^{*} ( {k}_{O} + 1 ) - {i}_{inv \_ i} ( {k}_{O} + 2 ) ] {i}_{inv \_ i}^{*} ( {k}_{O} ) - [ {i}_{inv \_ i}^{*} ( {k}_{U} + 1 ) - {i}_{inv \_ i} ( {k}_{U} + 2 ) ] {i}_{inv \_ i}^{*} ( {k}_{U} ) + {i}_{inv \_ i} ( {k}_{O} + 2 ) {i}_{inv \_ i} ( {k}_{O} + 1 ) + [ {i}_{inv \_ i}^{*} ( {k}_{U} + 1 ) - {i}_{inv \_ i} ( {k}_{U} + 2 ) ] {i}_{inv \_ i} ( {k}_{U} + 1 ) \} - {\sum }_{i = 1}^{n} {\sum }_{j = {k}_{O}}^{{k}_{U}} \frac{2 {R}_{f \_ i}}{{L}_{f \_ i}} {{i}_{inv \_ i} ( j + 1 )}^{2} ) , \qquad ( Eq . Set 37 )$$

$${\sum }_{i = 1}^{n} {i}_{inv \_ i}^{*} ( {k}_{S} + 1 ) {i}_{inv \_ i} ( {k}_{S} + 1 ) < {\sum }_{i = 1}^{n} \{ [ {i}_{inv \_ 1}^{*} ( {k}_{S} + 1 ) - {i}_{inv \_ i} ( {k}_{S} + 2 ) ] {i}_{inv \_ i}^{*} ( {k}_{S} ) - [ {i}_{inv \_ i}^{*} ( {k}_{U} + 1 ) - {i}_{inv \_ i} ( {k}_{U} + 2 ) ] {i}_{inv \_ i}^{*} ( {k}_{U} ) + {i}_{inv \_ i} ( {k}_{S} + 2 ) {i}_{inv \_ i} ( {k}_{S} + 1 ) + [ {i}_{inv \_ i}^{*} ( {k}_{U} + 1 ) - {i}_{inv \_ i} ( {k}_{U} + 2 ) ] {i}_{inv \_ i} ( {k}_{U} + 1 ) \} - {\sum }_{i = 1}^{n} {\sum }_{j = {k}_{S}}^{{k}_{U}} \frac{2 {R}_{{f}_{i}}}{{L}_{{f}_{i}}} {{i}_{inv \_ i} ( j + 1 )}^{2} )$$

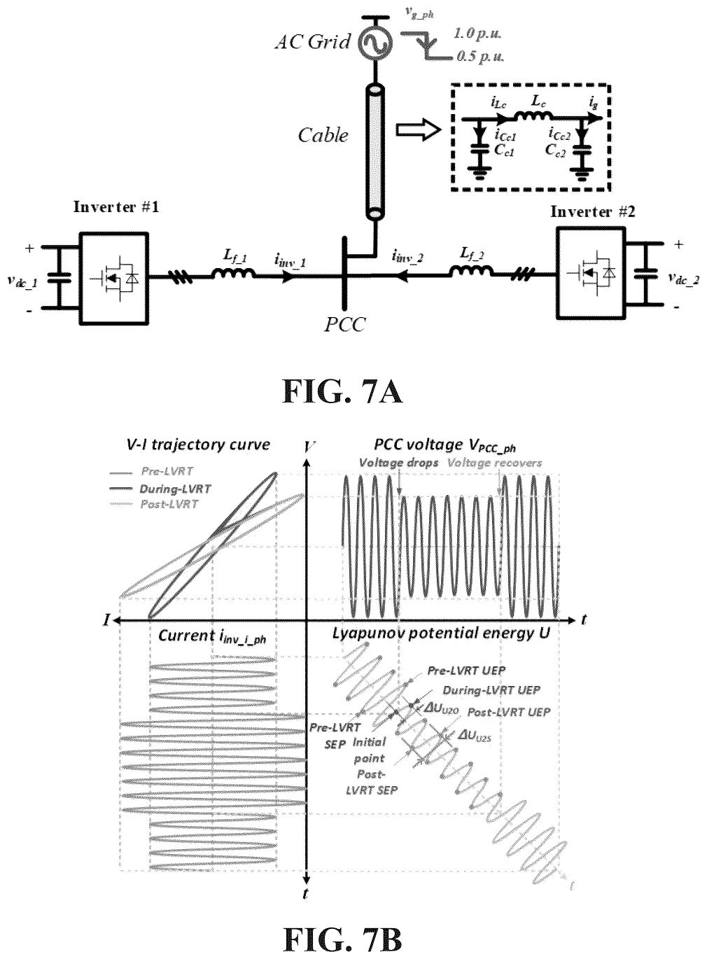

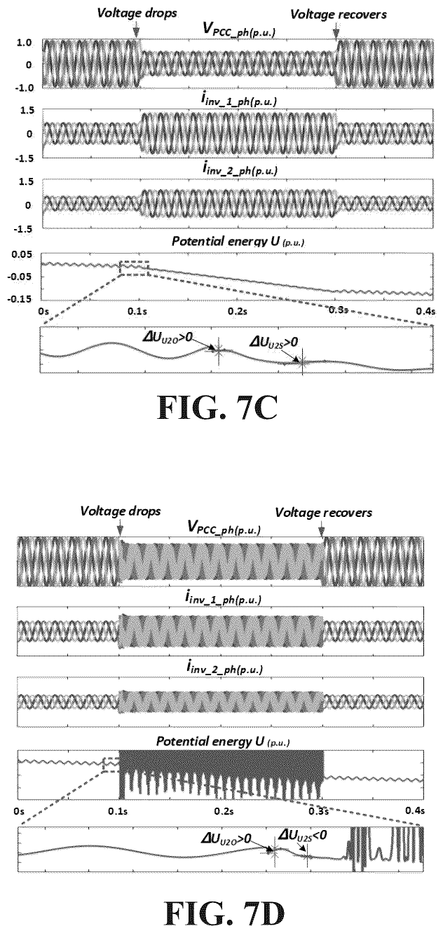

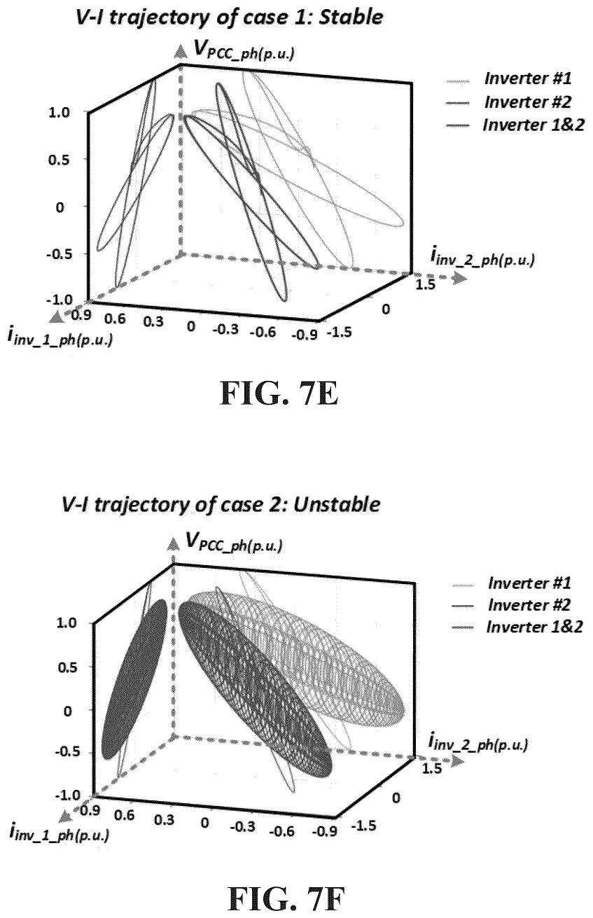

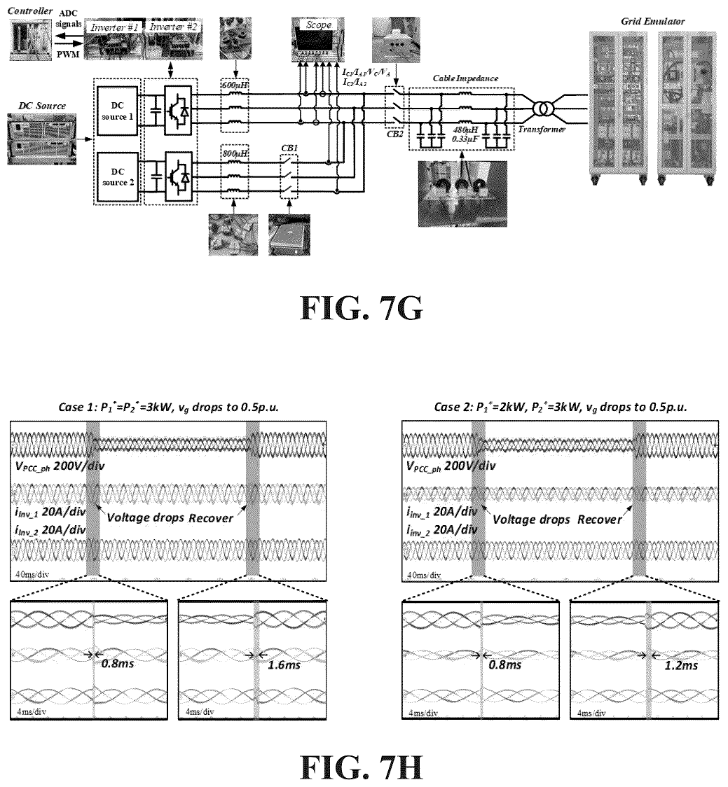

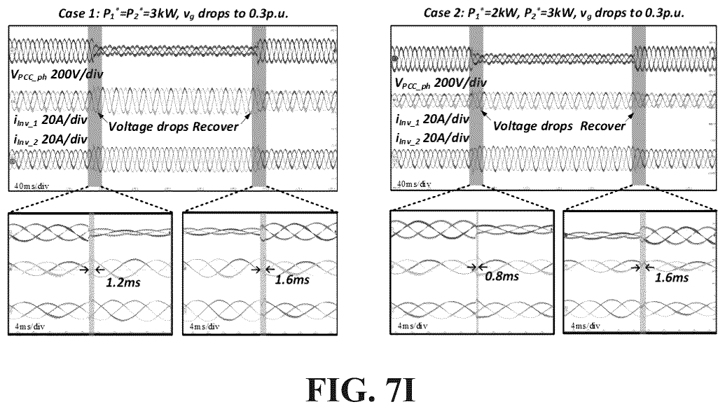

The developed stability criterion was applied to analyze and ensure the stability of a grid-tied two-inverter system during LVRT transients with a CLC grid impedance, as shown in FIG. 7A, with key parameters in Table 1.

TABLE 1
Base values

| | | |
|---|---|---|
| Voltage base value | 120 | V |
| Power base value | 5 | kVA |
| Frequency base value | 60 | Hz |

Parameters of the inverters and cable impedance (per-unit value)

| | |
|---|---|
| Inverter #1 | L_{f}_{_{—}}₁ = 0.08, R_{f}_{_{—}}₁ = 0.008, |
| | P*₁ = 0.6, Q*₁ = 0 |
| Inverter #2 | L_{f}_{_{—}}₂ = 0.10, R_{f}_{_{—}}₂ = 0.008, |
| | P*₂ = 0.4, Q*₂ = 0 |

Cable impedance: L_{c} = 0.06, C_{c1} = C_{c2} = 2.79

To evaluate stability, the potential energy of the Lyapunov function, U, for the two-inverter system was calculated to derive ΔU_{O2U} and ΔU_{S2U}. The PCC voltage, inverter current, and V-I trajectories of the two inverters were also presented to demonstrate the stable or unstable inverter behavior during LVRT transients, as shown in FIG. 7B.

The system dynamics affected by the cable can be defined per Equation 38.

$$\{ \begin{matrix}{L}_{c} \frac{{i}_{LC} ( k + 1 ) - {i}_{LC} ( k )}{{T}_{s}} = {v}_{PCC \_ ph} ( k ) - {v}_{g \_ ph} ( k ) \\ {C}_{c 1} \frac{{v}_{PCC \_ ph} ( k + 1 ) - {v}_{PCC \_ ph} ( k )}{{T}_{s}} = {i}_{inv \_ i} ( k ) - {i}_{{L}_{c}} ( k ) \\ {C}_{c 2} \frac{{v}_{g \_ ph} ( k + 1 ) - {v}_{g \_ ph} ( k )}{{T}_{s}} = {i}_{{L}_{c}} ( k ) - {i}_{g} ( k )\end{matrix} \qquad ( Eq . 38 )$$

The PCC voltage feedforward with a low-pass filter (LPF) helped improve the stability of traditional grid-tied inverter control [32′]; it was also beneficial for the exemplary deadbeat control to obtain a more accurate PCC voltage by removing most of the current harmonics, thereby enhancing inverter stability. The generation of inverter voltage reference considering LPF can be derived in Equation 39, where f_{c} is the cutoff frequency of LPF.

$${v}_{inv \_ i}^{*} ( k + 1 ) = \frac{{L}_{f \_ i}}{{T}_{s}} {i}_{inv \_ i}^{*} ( k + 1 ) + ( {R}_{f \_ i} - \frac{{L}_{f \_ i}}{{T}_{s}} ) {i}_{inv \_ i} ( k + 1 ) + \frac{{v}_{PCC \_ ph} ( k )}{1 + \frac{z - 1}{{f}_{c} {T}_{s} z}} \qquad ( Eq . 39 )$$

The inverter current at (k+1)th sampling cycle can be derived from Equation 39 and substituted into Equation Set 37 to certificate if the selected f_{c} ensured the stability.

The LVRT transients with different f_{c} were examined using a developed stability criterion. In the first case, the cutoff frequency f_{c} of both inverters is set as 1 kHz. FIGS. 7C-7D each shows simulation results for the two-inverter system under LVRT. As shown in FIG. 7C, the grid voltage dropped to 0.5 p.u. at 0.1 s, lasting for 0.2 s, then, the grid voltage recovered; the system remained stable. As shown in FIG. 7D, f_{c} was increased to 3 kHz, and voltage dropped to 0.50 p.u, showing that the system became unstable. FIGS. 7E-7F illustrate the V-I trajectories of the two-inverter system before, during, and after LVRT for FIG. 7C and FIG. 7D, respectively.

The V-I curve and Lyapunov function of the two-inverter system exhibited consistency with each other. The SEP corresponded to the local minimum of the potential energy U, while the UEP represented the local maximum. The initial point referred to the moment when the voltage drop occurred. From the potential energy plot shown in FIGS. 7C-7D, the UEP had a higher energy level than the initial point during LVRT (ΔU_{U2O}>0), indicating a stable transient process. After the voltage drop, ΔU_{U2S}>0 ensured that the SEP did not coincide with the UEP. However, if either energy margin, ΔU_{U2O} or ΔU_{U2S}, became negative, the system can become unstable, and the corresponding V-I trajectories can exhibit chaotic behavior.

Experimental Verification. FIG. 7G shows a two-inverter grid-tied experimental testbed established in the laboratory. The control algorithm was implemented on a digital controller (e.g., Myway PE-Expert4) to control two SiC inverters operating at 50 kHz switching frequency. The key parameters are given in Table 1 where v_{g}=120V/60 Hz; L_{f_1}=600 μH, L_{f_2}=800 μH, sampling frequency=50 kHz, C_{c1}=C_{c2}=0.33 μF, and L_{c}=480 μH. The cutoff frequency of LPF was set to 1 kHz to ensure stability during LVRT transients. A grid emulator generated two voltage drop conditions: a drop to 0.5 p.u. and a drop to 0.3 p.u. respectively.

FIG. 7H shows the experimental waveforms when vg dropped to 0.5 p.u and recovered after 0.2 seconds. In FIG. 7H, two cases were examined: Case 1: both inverters shared the same power; and Case 2: the power distribution between inverter #1 and inverter #2 was different.

The waveforms, from top to bottom, depicted the PCC voltage, measured current of inverter #1, and measured current of inverter #2, respectively. From the results shown in Case 1 in FIG. 7H, both inverters operated stably during the LVRT process. There was no current overshoot and voltage overshoot. Additionally, as shown in the zoomed-in figure, it took about 800 μs for the inverters to reach a steady state after the voltage dropped, demonstrating the response speed of the exemplary control method. During the recovery process, the transient response time was longer but remained quick, requiring about 1.6 ms to reach a steady state.

In case 2 in FIG. 7H, despite differences in power distribution, both inverters maintained stable operation during LVRT. The current overshoot and voltage overshoot remained minimal. Besides, the zoom-in figures revealed that both inverters stabilized in approximately 800 μs, while the recovery process was completed in about 1.2 ms. These results demonstrated that the exemplary control method achieved a fast dynamic response, even when the output power of the inverters varied.

FIG. 7I illustrates the experimental waveforms for both cases (e.g., Case 1, Case 2) when v_{g} dropped to 0.3 p.u. and recovered after 0.2 seconds. Although the voltage dropped deeper, both inverters operated stably during the LVRT transients, with minimal current and voltage overshoots.

In Case 1 in FIG. 71, the zoom-in figure shows that both inverters reach a steady state within approximately 1.2 ms, and the recovery process took about 1.6 ms, indicating that the exemplary control method can guarantee stable and fast operation even under more severe voltage drop conditions. In Case 2 in FIG. 7I, although the power distribution differed, both inverters still operated stably during the LVRT process. The zoom-in figure shows that the transient process lasted about 800 μs after the voltage dropped. The recovery process took about 1.6 ms. FIGS. 7H-7I demonstrate that the exemplary control method is robust and suitable for various conditions.

The experimental results in FIGS. 7H-7I validated the fast response and stability of the deadbeat-based multi-paralleled inverters during the LVRT process. The zoomed-in sections of the waveforms in FIGS. 7H-7I revealed minimal overshoot in both current and voltage, demonstrating that the exemplary control can achieve superior performance even under extreme large-signal dynamics, such as an LVRT event.

### Discussion

Discussion #1. Silicon Carbide (SiC) devices revolutionized the field of power electronics due to their properties compared to traditional silicon-based devices. These advantages include faster switching speeds, lower switching losses, and higher thermal conductivity, which provide higher efficiency and reduce cooling requirements [1]. As a result, SiC devices are used in various applications, such as renewable energy systems, electric vehicles, and grid-tied inverters.

One of the benefits of SiC devices is their ability to operate at higher switching frequencies. This capability allows for the reduction in the size of passive components, such as inductors and capacitors, which are crucial in filtering. For instance, in grid-tied inverters, the higher switching frequency of SiC devices can reduce the filter size, sometimes making a single L filter sufficient [2-4]. This not only reduces the overall system size and cost but also improves the inverter's dynamic response.

Despite these advantages, SiC grid-tied inverters face many challenges, particularly related to stability issues under various grid conditions. Traditional grid-following (GFL) control strategies, which consist of a current loop and a synchronization loop (e.g., phase-lock loop (PLL) and frequency-lock loop (FLL)), perform well under steady-state conditions. However, their performance degrades during dynamic events, such as grid faults, due to the limited bandwidth of the synchronization loop. This limitation becomes more pronounced in weak grid conditions, where the stability of these control strategies is poor. Additionally, the presence of cable impedance further complicates the stability and performance of the system, necessitating extra control loops to avoid instability [5], [6].

To address these challenges, the study developed a deadbeat control method with Low Voltage Ride-Through (LVRT) capabilities. The deadbeat control-based system can achieve instantaneous current control, robustly responding to grid faults and dynamic events [7], [8]. By incorporating LVRT capabilities, the exemplary system and method ensure that the inverter remains connected to the grid during voltage sag conditions, enhancing the overall stability and reliability of the power system [9-10].

Besides, the exemplary system and method was suitable for multi-paralleled inverters. Due to the difference between discrete-time systems and continuous-time systems, traditional stability analysis methods may not be suitable for deadbeat control. Therefore, the study investigated the equivalent circuit-based stability analysis method to demonstrate that the deadbeat control was faster than traditional control strategies with PLL or FLL, and it was also suitable for multi-paralleled inverter systems. Based on the equivalent circuit model, both the Lyapunov-based stability analysis of a single inverter and the Nyquist diagram of multi-paralleled inverters were presented. Furthermore, simulation and experimental results were provided to validate the theoretical analysis.

It was challenging to analyze the stability of deadbeat control applied to multi-paralleled grid-tied inverters, especially those designed to achieve LVRT capability. The study developed an equivalent circuit model for the deadbeat control method that achieved LVRT considering cable impedance conditions, demonstrating the fast dynamics enabled by the control. Based on this model, a Nyquist diagram was used to analyze the small-signal stability of the current loop in multi-paralleled grid-tied inverters, while a Lyapunov-based method was utilized to analyze the large-signal stability of a single inverter during the LVRT period. Both simulation and experimental results verified the validity of the stability analysis method.

Discussion #2. The increasing integration of renewable energy sources into the power grid led to a growing demand for highly efficient and fast power conversion systems. Silicon carbide (SiC) inverters, with their superior performance, fast switching speed, high efficiency, and large thermal conductivity, emerged as a promising solution for connecting renewable energies to the grid. Their ability to operate at high switching frequencies also enabled the use of a single small L-filter to effectively suppress switching harmonics, reduce overall system size, avoid oscillation caused by high-order filters and grid impedance, and enhance system dynamics [1′-3′].

However, despite these advantages, SiC inverters exacerbated stability challenges when connected to the grid due to their low inertia characteristics. This issue became critical for multiple units during grid disturbances, such as low-voltage ride-through (LVRT) events, essential for maintaining grid reliability. To meet LVRT requirements, inverters should remain connected and operational even during significant voltage drops. The low inertia of SiC inverters makes them more susceptible to these disturbances, increasing the risk of instability [2′], [4′-6′].

Traditional control methods for grid-tied inverters included a current loop and a PLL. In these conventional methods, inverter stability was usually achieved by tuning the PI control parameters for the inner current and outer PLL loop based on small-signal models [7′-9′]. However, these control parameters negatively impacted the inverter's transient response, leading to a trade-off between fast dynamics and system stability [10′]. To address this, some previous studies focused on optimizing control parameters to balance speed and stability [11′], [12′], while others explored adaptive control for real-time parameter adjustment [13], [14]. Nevertheless, because these control methods relied on small-signal models, stability during large dynamic events, such as LVRT, is not guaranteed. Furthermore, stability challenges became more prominent in multi-inverter systems due to coupling effects between inverters, making the system more prone to instability [15′]. Ensuring the stability of multi-parallel grid-tied inverters, especially during LVRT, became difficult by simply tuning the PI parameters. Additionally, PI-based control methods were not suited to the fast dynamic behavior of SiC inverters.

In contrast to traditional PI-based control, model predictive control (MPC), which was based on a different principle, was advantageous for achieving fast dynamics [16′], [17′]. There were two types of MPC: MPC with a continuous control set and the other was MPC with a finite control set (FCS-MPC) [18′]. Since the former was only suitable for systems with low-dimensional states [19′], FCS-MPC was the most commonly used approach. Unlike traditional PI control methods, FCS-MPC used a discrete model to predict the system's future behavior and then selected the optimal predicted state by minimizing a cost function [17′], [20′]. However, variable switching frequency and computational complexity made MPC difficult to apply to SiC inverters [21′], [22′]. Variable switching frequencies can spread harmonic spectra and unexpected resonances, while a long prediction horizon increased the computational cost.

Deadbeat-based predictive control offered a solution to address these inherent problems of FCS-MPC. Nevertheless, it still experienced the common issue of model-based predictive control methods: sensitivity to model accuracy. This was critical for multi-parallel grid-tied inverters, where predicting a wide range of grid impedance and accurately modeling multiple units' coupling effects was challenging. As a result, deadbeat control was often applied only to the inner current loop, and its sensitivity to uncertain model parameters is compensated by the outer loop's PLL PI control parameters [23′], [24′]. Consequently, stability issues associated with conventional PI control loops still existed, and the small-signal model-based design of PLL PI control parameters did not guarantee large-signal stability during events such as LVRT transients. Some previous studies have explored deadbeat control without PLL [25′], [26′], but these methods were only suitable for single-inverter systems with simple configurations, where model accuracy can be achieved. In multi-inverter systems that considered grid impedance, these methods were not applicable.

The small-signal model-based control method can require different control units with separately designed parameters for steady-state and LVRT modes. This approach necessitated accurate mode detection and a well-designed switching logic [27′], [28′]. An external hardware circuit may also be required to mitigate high inrush currents during LVRT transients [29′]. These mode transitions and the extra hardware can increase system cost and complexity while reducing overall system reliability. Some previous studies attempted to use MPC to achieve LVRT [30′], [31′], but this increased the computational burden and complicated the control scheme, which was unfavorable for inverters with fast switching frequency. The deadbeat method was developed for SiC inverter to achieve unified control for steady-state and LVRT, but it only applied to single units [25′]. Therefore, achieving unified control for multiple SiC grid-tied inverters in the presence of grid impedance remained a challenge.

To address the above issues, the study developed a unified control method for normal operation and LVRT based on the deadbeat principle for multiple SiC inverters connected to the grid. Unlike small signal-based control methods, the exemplary method did not need to tune PI control parameters and can achieve instantaneous current control without a PLL loop, guaranteed system stability under large-signal dynamics, and mitigated high inrush currents during LVRT transients without mode transitions or additional hardware. A PCC voltage feedforward with a low pass filter was implemented to obtain more accurate PCC voltage in the presence of grid impedance and the coupling effects between multiple units. The exemplary control method can require minimal computational cost, making it suitable for the fast switching frequencies of SiC inverters while maintaining a sampling frequency equal to the switching frequency. The stability of the exemplary control for multiple units was certified theoretically through the Lyapunov method. The inverter V-I trajectories during LVRT transients were developed and compared to those of conventional control methods to illustrate the ultrafast yet stable advantages of the proposed approach. Finally, the control method was applied to the SiC inverters operating at a switching frequency of 50 kHz. The experiment results of two grid-tied SiC inverters achieving stable LVRT confirmed the effectiveness of the exemplary method.

The study developed a direct deadbeat control method for multi-paralleled grid-tied SiC inverters with L-filter that can achieve switching-cycle-based ultrafast control and stable operation, even during large-signal dynamics such as LVRT transients in the presence of grid impedance. The exemplary control eliminated the need for PI loops, thereby, no need to tune PI parameters, which simplified the control design for multi-parallel inverters. Furthermore, the exemplary control method achieved seamless operation with no mode transition between normal conditions and LVRT transients.

The derived V-I trajectories demonstrated that the grid-tied inverter with the proposed deadbeat control behaved as an active impedance, minimizing dynamic transients to reach a steady state. As a result, small-signal-based stability analysis methods were inadequate for evaluating the stability of such an ultrafast inverter system.

The study developed a Lyapunov-function-based stability criterion for the exemplary multi-paralleled inverter system, which guaranteed the system stability. The developed stability criterion was applied to a two-inverter system selected as an experiment. Both simulation and experimental results and the Lyapunov function verified the advantages and validity of the exemplary control and its stability analysis. Furthermore, the exemplary control, the exemplary system's large-signal model, and their Lyapunov-based stability criterion can be the foundation for a digital twin of the power-electronics-dominated grid system, providing reliable and superior performance.

### Conclusion

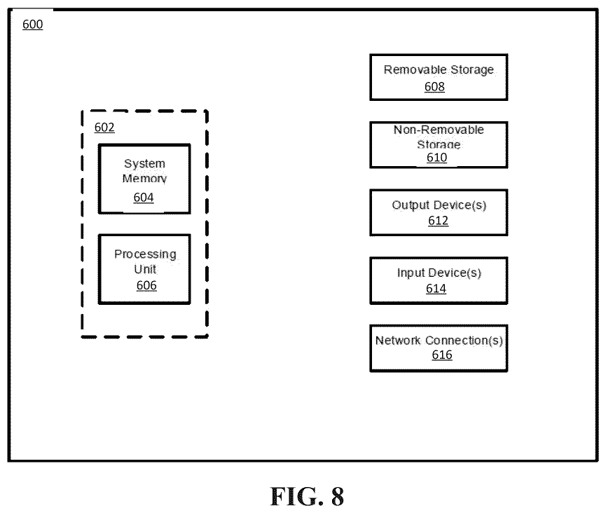

It should be appreciated that the logical operations described herein with respect to the various figures may be implemented (1) as a sequence of computer-implemented acts or program modules (i.e., software) running on a computing device (e.g., the computing device described in FIG. 8), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 8, an example computing device 600 upon which embodiments of the invention may be implemented is illustrated. It should be understood that the example computing device 600 is only one example of a suitable computing environment upon which embodiments of the invention may be implemented. Optionally, the computing device 600 can be all or a part of a well-known computing system including, but not limited to, controllers, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media. The disclosed computing device 600 may comprise all or a part of the controller used to implement the above-described methods of inverter control.

In its most basic configuration, computing device 600 typically includes at least one processing unit 606 and system memory 604. Depending on the exact configuration and type of computing device, system memory 604 may be volatile (such as random-access memory (RAM)), non-volatile (such as read-only memory (ROM), flash memory, etc.), or some combination of the two. This most basic configuration is illustrated in FIG. 8 by dashed line 602. The processing unit 606 may be a standard programmable processor that performs arithmetic and logic operations necessary for operation of the computing device 600. The computing device 600 may also include a bus or other communication mechanism for communicating information among various components of the computing device 600.

Computing device 600 may have additional features/functionality. For example, computing device 600 may include additional storage such as removable storage 608 and non-removable storage 610 including, but not limited to, magnetic or optical disks or tapes. Computing device 600 may also contain network connection(s) 616 that allow the device to communicate with other devices. Computing device 600 may also have input device(s) 614 such as a keyboard, mouse, touch screen, etc. Output device(s) 612 such as a display, speakers, printer, etc. may also be included. The additional devices may be connected to the bus in order to facilitate communication of data among the components of the computing device 600. All these devices are well known in the art and need not be discussed at length here.

The processing unit 606 may be configured to execute program code encoded in tangible, computer-readable media. Tangible, computer-readable media refers to any media that is capable of providing data that causes the computing device 600 (i.e., a machine) to operate in a particular fashion. Various computer-readable media may be utilized to provide instructions to the processing unit 606 for execution. Example tangible, computer-readable media may include, but is not limited to, volatile media, non-volatile media, removable media and non-removable media implemented in any method or technology for storage of information such as computer readable instructions, data structures, program modules or other data. System memory 604, removable storage 608, and non-removable storage 610 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 606 may execute program code stored in the system memory 604. For example, the bus may carry data to the system memory 604, from which the processing unit 606 receives and executes instructions. The data received by the system memory 604 may optionally be stored on the removable storage 608 or the non-removable storage 610 before or after execution by the processing unit 606.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications, and publications, as listed below and throughout this document, are hereby incorporated by reference in their entirety herein

Reference List #1

[1] Y. Shi, W. Lu., and H. Li, “Stability analysis and grid disturbance rejection for a 60-kW SiC-based filterless grid-connected PV inverter,” IEEE Trans. Ind. Appl., vol. 54, no. 5, pp. 5025-5038 September/October 2018.

[2] S. Madhusoodhanan et al., “Harmonic analysis and controller design of 15 kV SiC IGBT-based medium-voltage grid-connected three-phase three-level NPC converter,” IEEE Trans. Power Electron., vol. 32, no. 5, pp. 3355-3369 May 2017.

[3] J. Zhu et al., “A Novel Suppression Method for Grounding Transformer Against Earth Current From Urban Rail Transit,” IEEE Trans. Ind. Electron., vol. 68, no. 12, pp. 11651-11662, December 2021.

[4] J. Zhu, C. Mao, B. Liu, Z. Wang, D. Wang and H. Wang, “Design and Field Application of DC and Harmonic Suppression System for Neutral Current in 220 kV Substation,” IEEE Trans. Ind. Electron., vol. 69, no. 8, pp. 7560-7570 August 2022.

[5] X. Wang, F. Blaabjerg, and P. C. Loh, “Passivity-based stability analysis and damping injection for multiparalleled VSCs with LCL filters,” IEEE Trans. Power Electron., vol. 32, no. 11, pp. 8922-8935 November 2017,.

[6] X. Wang, F. Blaabjerg, and P. C. Loh, “Proportional derivative based stabilizing control of paralleled grid converters with cables in renewable power plants,” in Proc. IEEE Energy Convers. Congr. Expo., 2014, 4917-4924.

[7] X. Dong, and H. Li, “A PLL-less voltage sensorless direct deadbeat control for a SiC grid-tied inverter with LVRT capability under wide-range grid impedance,” IEEE Trans. Power Electron., vol. 38, no. 8, pp. 9469-9481 August 2023.

[8] P. Karamanakos, N. Mehrdad, and T. Geyer, “Fixed switching frequency direct model predictive control with continuous and discontinuous modulation for grid-tied converters with LCL filters,” IEEE Trans. Control Syst. Technol., vol. 29, no. 4, pp. 1503-1518 July 2021.

[9] N. N. Nam, N. D. Nguyen, C. Yoon, and M. Choi, and Y. I. Lee, “Voltage sensorless model predictive control for a grid-connected inverter with LCL filter,” IEEE Trans. Ind. Electron., vol. 69, no. 1, pp. 740-751, January 2022.

[10] C. Zheng, T. Dragi cevic, Z. Zhang, J. Rodriguez, and F. Blaabjerg, “Model predictive control of LC-filtered voltage source inverters with optimal switching sequence,” IEEE Trans. Power Electron., vol. 36, no. 3, pp. 3422-3436 March 2021.

[11] L. Liu, M. Xia, J. Fang, Q. Zhu and B. Qu, “New Criteria on Asymptotic Stability of Stochastic Differential Systems via Impulsive Control,” in IEEE Transactions on Circuits and Systems II: Express Briefs, vol. 71, no. 6, pp. 3036-3040 June 2024.

### Reference List #2

[1′] Y. Shi, L. Wang, R. Xie, Y. Shi, and H. Li, “A 60-kW 3-kW/kg five-levelT-type SiC PV inverter with 99.2% peak efficiency,” IEEE Trans. Ind.Electron., vol. 64, no. 11, pp. 9144-9154 November 2017.

[2′] Y. Shi, W. Lu., and H. Li, “Stability analysis and grid disturbance rejection for a 60-kW SiC-based filterless grid-connected PV inverter,” IEEE Trans. Ind. Appl., vol. 54, no. 5, pp. 5025-5038 September-October 2018.

[3′] N. He, M. Chen, J. Wu, N. Zhu, and D. Xu, “20-kW zero-voltage switching SiC-MOSFET grid inverter with 300 kHz switching frequency,” IEEE Trans. Power Electron., vol. 34, no. 6, pp. 5175-5190 June 2019.

[4′] M. Rajeev and V. Agarwal, “Low Voltage Ride-Through Capability of a Novel Grid Connected Inverter Suitable for Transformer-Less Solar PV-Grid Interface,” IEEE Trans. on Ind. Applicat., vol. 56, no. 3, pp. 2799-2806 May 2020.

[5′] M. Choopani, S. H. Hosseinian and B. Vahidi, “New Transient Stability and LVRT Improvement of Multi-VSG Grids Using the Frequency of the Center of Inertia,” IEEE Trans. Power Syst., vol. 35, no. 1, pp. 527-538, January 2020.

[6′] S. Madhusoodhanan et al., “Harmonic analysis and controller design of 15 kV SiC IGBT-based medium-voltage grid-connected three-phase three-level NPC converter,” IEEE Trans. Power Electron., vol. 32, no. 5, pp. 3355-3369 May 2017.

[7′] J. Hu, Q. Hu, et al, “Small Signal Instability of PLL-Synchronized Type-4 Wind Turbines Connected to High-Impedance AC Grid During LVRT,” IEEE Trans. Energy Convers., vol. 31, no. 4, pp. 1676-1687 December 2016.

[8′] X. Lin, J. Yu, et al, “Improving small signal stability of grid-connected inverter under weak grid by decoupling phase-lock loop and grid impedance,” IEEE Trans. Ind. Electron., vol. 69, no. 7, pp. 7040-7053 July 2022.

[9′] S. Zhou, X. Zou, et al “An Improved Design of Current Controller for LCL-Type Grid-Connected Converter to Reduce Negative Effect of PLL in Weak Grid,” IEEE J. Emerg. Sel. Topics Power Electron., vol. 6, no. 2, pp.648-663, June 2017.

[10′] L. Huang, H. Xin and F. Dörfler, “Hoo-Control of Grid-Connected Converters: Design, Objectives and Decentralized Stability Certificates,” IEEE Trans. Smart Grid, vol. 11, no. 5, pp. 3805-3816 September 2020.

[11′] B. Wen, D. Boroyevich, R. Burgos, P. Mattavelli, and Z. Shen, “Analysis of DQ small-signal impedance of grid-tied inverters,” IEEE Trans. Power Electron., vol. 31, no. 1, pp. 675-687, January 2016.

[12′] N. Pogaku, M. Prodanovic, and T. C. Green, “Modeling, analysis and testing of autonomous operation of an inverter-based microgrid,” IEEE Trans. Power Electron., vol. 22, no. 2,pp. 613-625, March 2007.

[13′] G. Liu, X. Cao, T. Shi and W. Wang, “Research on adaptive control of grid-connected PV inverters in weak grid,” 2015 IEEE Energy Conversion Congress and Exposition (ECCE), Montreal, QC, Canada, 2015, pp. 4229-4235.

[14′] X. Quan, A. Q. Huang, X. Dou, Z. Wu and M. Hu, “A novel adaptive control for three-phase inverter,” 2018 IEEE Applied Power Electronics Conference and Exposition (APEC), San Antonio, TX, USA, 2018, pp. 1014-1018.

[15′] T. Fang, S. Shen, Y. Jin and X. Ruan, “Robustness Investigation of Multi-Inverter Paralleled Grid-Connected System With LCL-Filter Based on the Grid-Impedance Allocation Mechanism,” IEEE Trans. Power Electron., vol. 36, no. 12, pp. 14508-14524, December 2021.

[16′] N. Jin, M. Chen, L. Guo, Y. Li and Y. Chen, “Double-Vector Model-Free Predictive Control Method for Voltage Source Inverter With Visualization Analysis,” IEEE Trans. Ind. Electron., vol. 69, no. 10, pp. 10066-10078, October 2022.

[17′] C. Zheng, T. Dragičević, Z. Zhang, J. Rodriguez and F. Blaabjerg, “Model Predictive Control of LC-Filtered Voltage Source Inverters With Optimal Switching Sequence,” IEEE Trans. Power Electron, vol. 36, no. 3, pp. 3422-3436 March 2021.

[18′] P. Cortes, M. P. Kazmierkowski, R. M. Kennel, D. E. Quevedo and J. Rodriguez, “Predictive Control in Power Electronics and Drives,” IEEE Trans. Ind. Electron., vol. 55, no. 12, pp. 4312-4324 December 2008.

[19′] P. Karamanakos, M. Nahalparvari and T. Geyer, “Fixed Switching Frequency Direct Model Predictive Control With Continuous and Discontinuous Modulation for Grid-Tied Converters With LCL Filters,” IEEE Trans. Control Syst. Technol., vol. 29, no. 4, pp. 1503-1518 July 2021.

[20′] T. Dragičević, “Model Predictive Control of Power Converters for Robust and Fast Operation of AC Microgrids,” IEEE Trans. Power Electron, vol. 33, no. 7, pp. 6304-6317 July 2018.

[21′] S. Vazquez, J. Rodriguez, M. Rivera, L. G. Franquelo, and M. Norambuena, “Model predictive control for power converters and drives: Advances and trends,” IEEE Trans. Ind. Electron., vol. 64, no. 2, pp. 935-947, February 2017.

[22′] C. Zheng, T. Dragi cevic, Z. Zhang, J. Rodriguez, and F. Blaabjerg, “Model predictive control of LC-filtered voltage source inverters with optimal switching sequence,” IEEE Trans. Power Electron., vol. 36, no. 3, pp. 3422-3436 March 2021.

[23′] M. G. Judewicz, S. A. González, J. R. Fischer, J. F. Martinez and D. O. Carrica, “Inverter-Side Current Control of Grid-Connected Voltage Source Inverters With LCL Filter Based on Generalized Predictive Control,” IEEE J. Emerging Sel. Top. Power Electron., vol. 6, no. 4, pp. 1732-1743 December 2018.

[24′] J. Castelló, J. M. Espí and R. García-Gil, “A New Generalized Robust Predictive Current Control for Grid-Connected Inverters Compensates Anti-Aliasing Filters Delay,” IEEE Trans. Ind. Electron., vol. 63, no. 7, pp. 4485-4494 July 2016.

[25′] X. Dong and H. Li, “A PLL-Less Voltage Sensorless Direct Deadbeat Control for a SiC Grid-Tied Inverter With LVRT Capability Under Wide-Range Grid Impedance,” IEEE Trans. Power Electron, vol. 38, no. 8, pp. 9469-9481 August 2023.

[26′] M. Kermadi et al., “Model-Free Predictive Current Controller for Voltage Source Inverters Using ARX Model and Recursive Least Squares,” IEEE Trans. Circuits Syst. II Express Briefs, vol. 71, no. 5, pp. 2619-2623 May 2024.

[27′] H. Wu and X. Wang, “Design-Oriented Transient Stability Analysis of PLL-Synchronized Voltage-Source Converters,” IEEE Trans. Power Electron, vol. 35, no. 4, pp. 3573-3589 April 2020.

[28′] Q. Hu, L. Fu, F. Ma, G. Wang, C. Liu and Y. Ma, “Impact of LVRT Control on Transient Synchronizing Stability of PLL-Based Wind Turbine Converter Connected to High Impedance AC Grid,” IEEE Trans. Power Syst vol. 38, no. 6, pp. 5445-5458 November 2023.

[29′] X. Dong et al., “SiC-based intelligent power stage with device prognosis &diagnosis and ZVRT capability,” in Proc. IEEE Appl. Power Electron. Conf. Expo., 2022, pp. 1525-1531.

[30′] M. Easley, S. Jain, M. Shadmand and H. Abu-Rub, “Autonomous Model Predictive Controlled Smart Inverter With Proactive Grid Fault Ride-Through Capability,” IEEE Trans. Energy Convers., vol. 35, no. 4, pp. 1825-1836 December 2020.

[31′] Javier Gutiérrez-Escalona, Carlos Roncero-Clemente, Oleksandr Husev, Fermín Barrero-González, Ana M. Llor, V. Fernão Pires, “Three-Level T-Type qZ Source Inverter as Grid-Following Unit for Distributed Energy Resources”, IEEE J. Emerging Sel. Top. Power Electron., vol.10, no.6, pp.7772-7785, 2022.

[32′] H. Gong, X. Wang and L. Harnefors, “Rethinking Current Controller Design for PLL-Synchronized VSCs in Weak Grids,” IEEE Trans. Power Electron, vol. 37, no. 2, pp. 1369-1381 February 2022.

What is claimed is:

1. A control system for a network of grid inverters having at least one grid inverter, including a first inverter, the control system comprising:
a first controller operatively coupled to the first grid inverter, the first controller comprising:
a first low-voltage-ride-through (LVRT) detection unit configured to:
measure, in a first control cycle, a first point-of-common-coupling (PCC) voltage;
receive, in the first control cycle, a first real power reference and a first reactive power reference; and
in response to the measured first PCC voltage meeting an LVRT condition, generate a reformed first active power reference and a reformed first reactive power reference;
a first current reference generation unit operatively coupled to the first LVRT detection unit, the current reference generation unit being configured to:
in response to the measured PCC voltage meeting the LVRT condition, generate a first three-phase instantaneous current reference using the measured first PCC voltage, the reformed first active power reference, and the reformed first reactive power reference; and
in response to the measured PCC voltage not meeting the LVRT condition, generate the first three-phase instantaneous current reference using the measured first PCC voltage, the first real power reference, and the first reactive power reference;
a first deadbeat-based current control unit operatively coupled to the first current reference generation unit, the deadbeat-based current control being configured to:
receive, in the first control cycle, a first inverter current from the first grid inverter; and
generate, in the first control cycle, a first voltage reference using the first three-phase instantaneous current reference, the first inverter current, and the measured first PCC voltage, wherein the first voltage reference is used to make the first inverter current reach the first three-phase instantaneous current reference in a second control cycle;
a first modulation unit operatively coupled to the first current reference generation unit, the first modulation unit being configured to:
generate, in the first control cycle, a first switching signal by modulating the generated first voltage reference; and
output the first switching signal to the network of grid inverters for controls in subsequent control cycles.

2. The control system of claim 1, wherein each grid inverter is coupled with an inductive low-pass filter configured to reduce alternating current (AC) components of an inverter current of the grid inverter.

3. The control system of claim 1 further comprising:
a second controller operatively coupled to a second grid inverter, the second controller comprising:
a second low-voltage-ride-through (LVRT) detection unit configured to:
measure, in the first control cycle, a second point-of-common-coupling (PCC) voltage;
receive, in the first control cycle, a second real power reference and a second reactive power reference; and
in response to the measured second PCC voltage meeting an LVRT condition, generate a reformed second active power reference and a reformed second reactive power reference;
a second current reference generation unit operatively coupled to the first LVRT detection unit, the current reference generation unit being configured to:
in response to the measured PCC voltage meeting the LVRT condition, generate a second three-phase instantaneous current reference using the measured first PCC voltage, the reformed second active power reference, and the reformed second reactive power reference; and
in response to the measured PCC voltage not meeting the LVRT condition, generate the second three-phase instantaneous current reference using the measured first PCC voltage, the second real power reference, and the second reactive power reference;
a second deadbeat-based current control unit operatively coupled to the second current reference generation unit, the deadbeat-based current control being configured to:
receive, in the first control cycle, a second inverter current from the second grid inverter; and
generate, in the first control cycle, a second voltage reference using the second three-phase instantaneous current reference, the second inverter current, and the measured second PCC voltage, wherein the second voltage reference is used to make the second inverter current reach the second three-phase instantaneous current reference in the second control cycle;
a second modulation unit operatively coupled to the second current reference generation unit, the second modulation unit being configured to:
generate, in the first control cycle, a second switching signal by modulating the generated second voltage reference; and
output the second switching signal to the network of grid inverters for controls in subsequent control cycles.

4. The control system of claim 1, wherein the first grid inverter and the second grid inverter are connected in parallel.

5. The control system of claim 4, wherein the network of grid inverters is coupled to an AC grid via a cable, wherein the cable has a cable impedance.

6. A method for controlling a network of grid inverters having at least one grid inverter, including a first grid inverter, the method comprising:
measuring, in a first control cycle, a first point-of-common-coupling (PCC) voltage;
receiving, in the first control cycle, a first real power reference and a first reactive power reference;
in response to the measured first PCC voltage meeting an LVRT condition, generating a reformed first active power reference and a reformed first reactive power reference;
in response to the measured PCC voltage meeting the LVRT condition, generating a first three-phase instantaneous current reference using the measured first PCC voltage, the reformed first active power reference, and the reformed first reactive power reference;
in response to the measured PCC voltage not meeting the LVRT condition, generating the first three-phase instantaneous current reference using the measured first PCC voltage, the first real power reference, and the first reactive power reference;
receiving, in the first control cycle, a first inverter current from the first grid inverter;
generating, in the first control cycle, a first voltage reference using the first three-phase instantaneous current reference, the first inverter current, and the measured first PCC voltage, wherein the first voltage reference is used to make the first inverter current reach the first three-phase instantaneous current reference in a second control cycle;
generating, in the first control cycle, a first switching signal by modulating the generated first voltage reference; and
outputting the first switching signal to the grid inverters for controls.

7. The method of claim 6, wherein the network of grid inverters further comprises a second grid inverter, the method of claim 6 further comprising:
measuring, in the first control cycle, a second point-of-common-coupling (PCC) voltage;
receiving, in the first control cycle, a second real power reference and a second reactive power reference;
in response to the measured second PCC voltage meeting an LVRT condition, generating a reformed second active power reference and a reformed second reactive power reference;
in response to the measured PCC voltage meeting the LVRT condition, generating a second three-phase instantaneous current reference using the measured first PCC voltage, the reformed second active power reference, and the reformed second reactive power reference;
in response to the measured PCC voltage not meeting the LVRT condition, generating the second three-phase instantaneous current reference using the measured first PCC voltage, the second real power reference, and the second reactive power reference;
receiving, in the first control cycle, a second inverter current from the second grid inverter;
generating, in the first control cycle, a second voltage reference using the second three-phase instantaneous current reference, the second inverter current, and the measured second PCC voltage, wherein the second voltage reference is used to make the second inverter current reach the second three-phase instantaneous current reference in the second control cycle;
generating, in the first control cycle, a second switching signal by modulating the generated second voltage reference; and
outputting the second switching signal to the grid inverters for controls.

8. The method of claim 6, wherein each grid inverter is coupled with an inductive low-pass filter configured to reduce alternating current (AC) components of an inverter current of the grid inverter.

9. The method of claim 6, wherein the first grid inverter and the second grid inverter are connected in parallel.

10. The method of claim 9, wherein the network of grid inverters is coupled to an AC grid via a cable, wherein the cable has a cable impedance.

11. A non-transitory computer-readable medium for controlling a network of grid inverters having at least one grid inverter, including a first grid inverter, having instructions stored thereon, wherein execution of the instructions by a processor causes the processor to:
measure, in a first control cycle, a first point-of-common-coupling (PCC) voltage;
receive, in the first control cycle, a first real power reference and a first reactive power reference;
in response to the measured first PCC voltage meeting an LVRT condition, generate a reformed first active power reference and a reformed first reactive power reference;
in response to the measured PCC voltage meeting the LVRT condition, generate a first three-phase instantaneous current reference using the measured first PCC voltage, the reformed first active power reference, and the reformed first reactive power reference;
in response to the measured PCC voltage not meeting the LVRT condition, generate the first three-phase instantaneous current reference using the measured first PCC voltage, the first real power reference, and the first reactive power reference;
receive, in the first control cycle, a first inverter current from the first grid inverter;
generate, in the first control cycle, a first voltage reference using the first three-phase instantaneous current reference, the first inverter current, and the measured first PCC voltage, wherein the first voltage reference is used to make the first inverter current reach the first three-phase instantaneous current reference in a second control cycle;
generate, in the first control cycle, a first switching signal by modulating the generated first voltage reference; and
output the first switching signal to the grid inverters for controls.

12. The non-transitory computer-readable medium of claim 11, wherein the network of grid inverters further comprises a second grid inverter, wherein execution of the instructions by a processor further causes the processor to:
measure, in the first control cycle, a second point-of-common-coupling (PCC) voltage;
receive, in the first control cycle, a second real power reference and a second reactive power reference;
in response to the measured second PCC voltage meeting an LVRT condition, generate a reformed second active power reference and a reformed second reactive power reference;
in response to the measured PCC voltage meeting the LVRT condition, generate a second three-phase instantaneous current reference using the measured first PCC voltage, the reformed second active power reference, and the reformed second reactive power reference;
in response to the measured PCC voltage not meeting the LVRT condition, generate the second three-phase instantaneous current reference using the measured first PCC voltage, the second real power reference, and the second reactive power reference;
receive, in the first control cycle, a second inverter current from the second grid inverter;
generate, in the first control cycle, a second voltage reference using the second three-phase instantaneous current reference, the second inverter current, and the measured second PCC voltage, wherein the second voltage reference is used to make the second inverter current reach the second three-phase instantaneous current reference in the second control cycle;
generate, in the first control cycle, a second switching signal by modulating the generated second voltage reference; and
output the second switching signal to the grid inverters for controls.

13. The non-transitory computer-readable medium of claim 11, wherein each grid inverter is coupled with an inductive low-pass filter configured to reduce alternating current (AC) components of an inverter current of the grid inverter.

14. The non-transitory computer-readable medium of claim 11, wherein the first grid inverter and the second grid inverter are connected in parallel.

15. The non-transitory computer-readable medium of claim 14, wherein the network of grid inverters is coupled to an AC grid via a cable, wherein the cable has a cable impedance.
